(19) United States
(12) Patent Application Publication
(10) Pub. No.: US 2022/0405349 A1
(43) Pub. Date: Dec. 22, 2022

(54) DATA PROCESSING METHOD AND APPARATUS, AND RELATED PRODUCT

(71) Applicant: Cambricon Technologies Corporation Limited, Beijing (CN)

(72) Inventors: Yingnan ZHANG, Beijing (CN); Hongbo ZENG, Beijing (CN); Yao ZHANG, Beijing (CN); Shaoli LIU, Beijing (CN); Di HUANG, Beijing (CN); Shiyi ZHOU, Beijing (CN); Xishan ZHANG, Beijing (CN); Chang LIU, Beijing (CN); Jiaming GUO, Beijing (CN); Yufeng GAO, Beijing (CN)

(21) Appl. No.: 17/773,502

(22) PCT Filed: Oct. 27, 2020
(86) PCT No.: PCT/CN2020/123854

§ 371 Date: Apr. 29, 2022

(30) Foreign Application Priority Data
Nov. 1, 2019 (CN) 201911061461.9

(51) Int. Cl. G06F 17/16; G06F 7/50; G06F 7/523

(52) U.S. Cl. CPC G06F 17/16; G06F 7/50; G06F 7/523

(57) ABSTRACT

This disclosure relates to a data processing method, a data processing apparatus, and related products. The products include a control unit. The control unit includes: an instruction caching unit, an instruction processing unit, and a storage queue unit. The instruction caching unit is used for storing a calculation instruction associated with an artificial neural network computation; the instruction processing unit is used for parsing the calculation instruction to obtain a plurality of computation instructions; and the storage queue unit is used for storing an instruction queue, where the instruction queue includes the plurality of computation instructions or calculation instructions to be executed according to a front-back sequence of a queue. Through the above method of this disclosure, computation efficiency of the related products during a neural network model computation may be improved.

### CROSS REFERENCE TO RELATED APPLICATION

This application claims priority to Chinese patent application No. 201911061461.9 filed on Nov. 1, 2019 and entitled “DATA PROCESSING METHOD AND APPARATUS, AND RELATED PRODUCT”. The content of the aforementioned application is herein incorporated by reference in its entirety.

### TECHNICAL FIELD

This disclosure relates to the technical field of data processing and in particular relates to a kind of data processing method and apparatus, and related products.

### BACKGROUND

In the technical field of artificial intelligence, a neural network algorithm is a currently-popular machine learning algorithm and has achieved very good results in many fields, such as image recognition, speech recognition, natural language processing, and the like. With the development of the neural network algorithm, algorithm complexity becomes higher and in order to improve the degree of recognition, a model scale becomes larger. Processing these large-scale models with a central processing unit (CPU) and a graphics processing unit (GPU) results in enormous calculation time and large power consumption.

### SUMMARY

In view of the situation above, a data processing method, a data processing apparatus, and related products that may reduce calculation amount, save calculation time, and reduce power consumption are provided.

According to a first aspect of the present disclosure, a data processing method is provided, including: splitting a convolutional kernel with a size greater than 3*3 into a plurality of sub convolutional kernels with a size less than or equal to 3*3; splitting input data into a plurality of pieces of target sub input data with a size less than or equal to 4*4 according to position distributions of the plurality of sub convolutional kernels in the convolutional kernel, where a sub convolutional kernel corresponds to one or more pieces of target sub input data; for any one of the sub convolutional kernels, performing a winograd convolution operation on the sub convolutional kernel and corresponding target sub input data to obtain a convolution result corresponding to the sub convolutional kernel; and performing a summation operation on convolution results corresponding to the plurality of sub convolutional kernels to obtain a convolution result of the convolutional kernel and the input data.

According to a second aspect of the present disclosure, a data processing apparatus is provided, including: a convolutional kernel splitting unit configured to split a convolutional kernel with a size greater than 3*3 into a plurality of sub convolutional kernels with a size less than or equal to 3*3; an input data splitting unit configured to split input data into a plurality of pieces of target sub input data with a size less than or equal to 4*4 according to position distributions of the plurality of sub convolutional kernels in the convolutional kernel, where a sub convolutional kernel corresponds to one or more pieces of target sub input data; a convolution unit configured to, for any one of the sub convolutional kernels, perform a winograd convolution operation on the sub convolutional kernel and corresponding target sub input data to obtain a convolution result corresponding to the sub convolutional kernel; and a summation unit configured to perform a summation operation on convolution results corresponding to the plurality of sub convolutional kernels to obtain a convolution result of the convolutional kernel and the input data.

According to a third aspect of the present disclosure, an artificial intelligence chip is provided, which includes the data processing apparatus of the second aspect above.

According to a fourth aspect of the present disclosure, an electronic device is provided, which includes the artificial intelligence chip of the third aspect above.

According to a fifth aspect of the present disclosure, an electronic device is provided, which includes: processors; and a memory for storing instructions executable by the processors, where the processors are configured to perform the data processing method of the first aspect above.

According to a sixth aspect of the present disclosure, a non-transitory computer-readable storage medium is provided, on which a computer program instruction is stored, where the computer program instruction implements the data processing method of the first aspect above when executed by a processor.

By splitting a convolutional kernel with a size greater than 3*3 into a plurality of sub convolutional kernels with a size less than or equal to 3*3, and splitting input data into a plurality of pieces of target sub input data with a size less than or equal to 4*4 according to position distributions of the plurality of sub convolutional kernels in the convolutional kernel, where a sub convolutional kernel corresponds to one or more pieces of target sub input data, and then for any one of the sub convolutional kernels, performing a winograd convolution operation on the sub convolutional kernel and corresponding target sub input data to obtain a convolution result corresponding to the sub convolutional kernel, a summation operation is performed on convolution results corresponding to the plurality of sub convolutional kernels to obtain a convolution result of the convolutional kernel and the input data. After the convolutional kernel is split into the convolutional kernel with the size less than or equal to 3*3 and the input data is split into the input data with the size less than or equal to 4*4, since there is no fractional number in a transformation matrix corresponding to the convolutional kernel with the size less than or equal to 3*3 and the input data with the size less than or equal to 4*4, during the winograd convolution operation, multiplication computations are not required and only through a shift and a summation computation, the convolution result is obtained, thereby reducing the calculation amount, saving the calculation time and reducing the power consumption.

Other features and aspects of the present disclosure will be clear based on detailed descriptions of exemplary embodiments with reference to drawings.

### DESCRIPTION OF THE DRAWINGS

Drawings are included in the specification and constitute a part of the specification. Together with the specification, the drawings illustrate exemplary embodiments, features, and aspects of the present disclosure, and are used to explain principles of the present disclosure.

FIG. 1 illustrates a diagram of a processor performing a data processing method according to an embodiment of the present disclosure.

FIG. 2 illustrates a flowchart of a data processing method according to an embodiment of the present disclosure.

FIG. 3 illustrates a diagram of splitting a 5*5 convolutional kernel into a plurality of sub convolutional kernels according to an embodiment of the present disclosure.

FIG. 4 illustrates a diagram of splitting 8*8 input data into a plurality of pieces of first sub input data based on a splitting method for a 5*5 convolutional kernel shown in FIG. 3 according to an embodiment of the present disclosure.

FIG. 5 illustrates a diagram of a plurality of pieces of target sub input data with a size less than or equal to 4*4 corresponding to a sub convolutional kernel obtained based on first sub input data corresponding to the sub convolutional kernel shown in FIG. 4 according to an embodiment of the present disclosure.

FIG. 6 illustrates a schematic structural diagram of a data processing apparatus according to an embodiment of the present disclosure.

FIG. 7 illustrates a structural block diagram of a board card according to an embodiment of the present disclosure.

### DETAILED DESCRIPTION

Technical solutions in embodiments of the present disclosure will be described clearly and completely hereinafter with reference to drawings in the embodiments of the present disclosure. Obviously, embodiments to be described are merely some of, but not all of embodiments of the present disclosure. All other embodiments obtained by those of ordinary skill in the art based on the embodiments of the present disclosure without creative efforts shall fall within the protection scope of the present disclosure.

It should be understood that terms such as “first”, “second”, and “third” in the claims, the specification, and drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more other features, entities, steps, operations, elements, components, and/or collections thereof.

It should also be understood that terms used in the specification of the present disclosure are merely for a purpose of describing a particular embodiment rather than limiting the present disclosure. As being used in the specification and the claims of the disclosure, unless the context clearly indicates otherwise, singular forms such as “a”, “an” and “the” are intended to include plural forms. It should also be understood that a term “and/or” used in the specification and the claims refers to any and all possible combinations of one or more of relevant listed items and includes these combinations.

As being used in this specification and the claims, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

The data processing method according to embodiments of the present disclosure may be applied in a processor. The processor may be a general-purpose processor, such as a central processing unit (CPU), or an intelligence processing unit (IPU) for performing artificial intelligence computations. The artificial intelligence computations may include machine learning computations, brain-like computations, and the like. The machine learning computations may include a neural network computation, a k-means computation, a support vector machine computation, and the like. The IPU may include one or a combination of, for example, a graphics processing unit (GPU), a neural-network processing unit (NPU), a digital signal processor (DSP), and a field-programmable gate array (FPGA) chip. The present disclosure does not limit a specific type of the processor.

In a possible implementation, the processor referred in the present disclosure may include a plurality of processing units, and the processing units may independently run tasks assigned, such as a convolution computation task, a pooling task or a fully-connected task, and the like. The present disclosure does not limit the processing units and the tasks executed by the processing units.

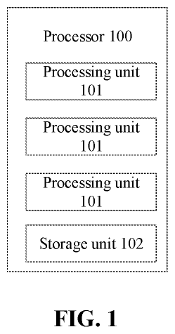

FIG. 1 illustrates a diagram of a processor performing a data processing method according to an embodiment of the present disclosure. As shown in FIG. 1, a processor 100 may include a plurality of processing units 101 and a storage unit 102. The plurality of processing units 101 may be configured to execute an instruction sequence. The storage unit 102 may be configured to store data, and may include a random access memory (RAM) and a register file. The plurality of processing units 101 in the processor 100 may share part of a storage space. For example, the plurality of processing units 101 may share part of the storage space of the RAM and the register file, and may also have their own storage spaces at the same time.

Winograd convolution is a convolution acceleration implementation based on a polynomial interpolation algorithm. The Winograd convolution performs a linear transformation (such as a winograd forward transformation) on two inputs of a convolution operation: input data (a neuron) and a convolutional kernel (a weight) respectively after splitting the input data and the convolutional kernel on a certain scale, and then performs an element-wise multiplication on the input data after the transformation and the convolutional kernel after the transformation, and finally performs another linear transformation (such as a winograd backward transformation) on the element-wise multiplication result to obtain a convolution result equivalent to an original convolution operation. The input data may be image data, sound data, or video data. Taking a case that the input data is the image data as an example, the input data may be expressed in the form of NHWC (batch height width channels), where N may represent the number of images, HW may represent the number of pixels in dimensions of height and width respectively, and C may represent the number of channels. For example, C may represent three channels of RGB (Red Green Blue). It should be noted that the above representation is only an example of the present disclosure, and the present disclosure is not limited to the above representation.

The expression of a winograd transformation is shown as follows.

For the input data and the convolutional kernel that are one-dimensional: S=A^{T}((Gg)⊙(B^{T}d)).

For the input data and the convolutional kernel that are two-dimensional: S=A^{T}((GgG^{T})⊙(B^{T}dB)) A.

g denotes the convolutional kernel, G denotes a left-multiply forward transformation matrix corresponding to the convolutional kernel, G^{T} denotes a right-multiply forward transformation matrix corresponding to the convolutional kernel, d denotes the input data, B denotes a right-multiply forward transformation matrix corresponding to the input data, B^{T} denotes a left-multiply forward transformation matrix corresponding to the input data, ⊙ denotes an element-wise multiplication computation, A denotes a right-multiply backward transformation matrix, A^{T} denotes a left-multiply backward transformation matrix. For input data with a different dimension, there are corresponding B and B^{T}; similarly, for a convolutional kernel with a different dimension, there are corresponding G and G^{T}.

Replacing the original convolution operation by the winograd convolution may bring great technical effects in hardware efficiency ratio improvement and calculation time reduction and may simultaneously achieve better neural network performance when no or less extra hardware overheads are increased.

However, in the winograd convolution, for convolutional kernels and input data that have different sizes, transformation matrices with different sizes are required. When the convolutional kernels are large and/or the input data is large, there are fractional numbers in the transformation matrices, resulting in enormous calculation time during calculation processes of a lot of multiplication computations and precision reduction of a winograd convolution result.

The present disclosure provides a data processing method. According to the method, the convolutional kernel is split into a convolutional kernel with a size less than or equal to 3*3 and the input data is split into input data with a size less than or equal to 4*4. Since there is no fractional number in a transformation matrix corresponding to the convolutional kernel with the size less than or equal to 3*3 and the input data with the size less than or equal to 4*4, during a winograd convolution operation, multiplication computations are not required and only through a shift and a summation computation, a convolution result is obtained, thereby reducing calculation amount, saving calculation time, reducing power consumption, and improving precision of the convolution result.

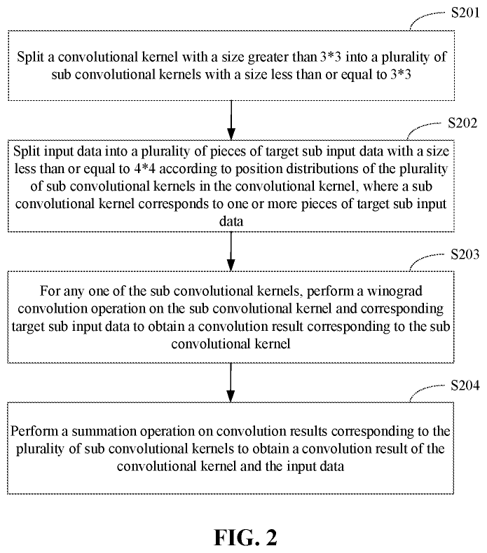

FIG. 2 illustrates a flowchart of a data processing method according to an embodiment of the present disclosure. As shown in FIG. 2, the method includes:

in a step S201: splitting a convolutional kernel with a size greater than 3*3 into a plurality of sub convolutional kernels with a size less than or equal to 3*3;

in a step S202: splitting input data into a plurality of pieces of target sub input data with a size less than or equal to 4*4 according to position distributions of the plurality of sub convolutional kernels in the convolutional kernel, where a sub convolutional kernel corresponds to one or more pieces of target sub input data;

in a step S203: for any one of the sub convolutional kernels, performing a winograd convolution operation on the sub convolutional kernel and corresponding target sub input data to obtain a convolution result corresponding to the sub convolutional kernel; and

in a step S204: performing a summation operation on convolution results corresponding to the plurality of sub convolutional kernels to obtain a convolution result of the convolutional kernel and the input data.

In practical applications, there is no fractional number in a transformation matrix corresponding to the convolutional kernel with the size less than or equal to 3*3 and the input data with the size less than or equal to 4*4. According to the data processing method of the present disclosure, the convolutional kernel is split into a convolutional kernel with the size less than or equal to 3*3 and the input data is split into input data with the size less than or equal to 4*4, and therefore, during a winograd convolution operation, multiplication computations are not required and only through a shift and a summation computation, a convolution result is obtained, thereby reducing calculation amount, saving calculation time, reducing power consumption, and improving precision of the convolution result.

In a possible implementation, splitting the convolutional kernel with the size greater than 3*3 into the plurality of sub convolutional kernels with the size less than or equal to 3*3 includes: splitting the convolutional kernel into the plurality of sub convolutional kernels with the size less than or equal to 3*3 that do not overlap with each other.

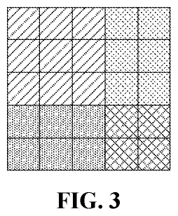

FIG. 3 illustrates a diagram of splitting a 5*5 convolutional kernel into a plurality of sub convolutional kernels according to an embodiment of the present disclosure. As shown in FIG. 3, the 5*5 convolutional kernel is split into four sub convolutional kernels: a 3*3 sub convolutional kernel, a 3*2 sub convolutional kernel, a 2*3 sub convolutional kernel, and a 2*2 sub convolutional kernel.

Based on a splitting of a convolutional kernel, input data is similarly split to obtain one or more pieces of target sub input data corresponding to a sub convolutional kernel.

In a possible implementation, splitting the input data into a plurality of pieces of target sub input data with a size less than or equal to 4*4 based on position distributions of the plurality of sub convolutional kernels in the convolutional kernel includes: splitting the input data into a plurality of pieces of first sub input data based on the position distributions of the plurality of sub convolutional kernels in the convolutional kernel, where any one of the sub convolutional kernels has uniquely-corresponding first sub input data; for any one of the sub convolutional kernels, if a size of first sub input data corresponding to the sub convolutional kernel is larger than 4*4, splitting first sub input data with a size larger than 4*4 into a plurality of pieces of second sub input data with a size smaller than or equal to 4*4; and determining the plurality of pieces of second sub input data with the size smaller than or equal to 4*4 as target sub input data corresponding to the sub convolutional kernel.

In a possible implementation, the method further includes: for any one of the sub convolutional kernels, if the size of the first sub input data corresponding to the sub convolutional kernel is less than or equal to 4*4, determining the first sub input data as the target sub input data corresponding to the sub convolutional kernel.

In a possible implementation, for any one of the sub convolutional kernels, a corresponding relationship between the sub convolutional kernel and corresponding first sub input data is as follows: a position of a first element of the sub convolutional kernel in the convolutional kernel is the same as a position of a first element of the corresponding first sub input data in the input data; the first sub input data is composed of elements that may be traversed by the sub convolutional kernel when the convolutional kernel traverses elements of the input data.

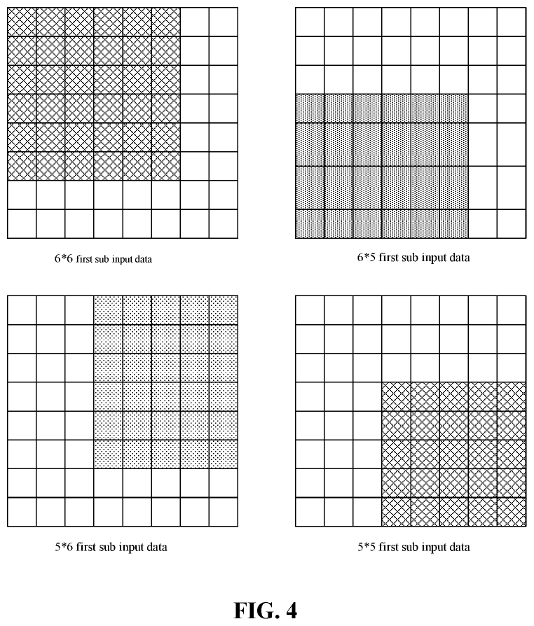

Still taking FIG. 3 as an example, 8*8 input data is split according to a splitting method for the 5*5 convolutional kernel shown in FIG. 3. FIG. 4 illustrates a diagram of splitting 8*8 input data into a plurality of pieces of first sub input data based on a splitting method for a 5*5 convolutional kernel shown in FIG. 3 according to an embodiment of the present disclosure.

As shown in FIG. 4, since a first element in a 3*3 sub convolutional kernel is located in row 1 and column 1 of the convolutional kernel, the first element in first sub input data corresponding to the 3*3 sub convolutional kernel is located in row 1 and column 1 of input data, and elements included in the first sub input data are composed of elements that may be traversed by the 3*3 sub convolutional kernel when the 5*5 convolutional kernel traverses elements of the 8*8 input data. In other words, the first sub input data corresponding to the 3*3 sub convolutional kernel is 6*6 first sub input data composed of elements of rows 1-6 and columns 1-6 of the input data.

Since the first element in a 3*2 sub convolutional kernel is located in row 1 and column 4 of the convolutional kernel, the first element in the first sub input data corresponding to the 3*2 sub convolutional kernel is located in row 1 and column 4 of the input data, and the elements included in this first sub input data are composed of the elements that may be traversed by a 2*3 sub convolutional kernel when the 5*5 convolutional kernel traverses the elements of the 8*8 input data. In other words, the first sub input data corresponding to the 2*3 sub convolutional kernel is 6*5 first sub input data composed of elements of rows 1-6 and columns 4-8 of the input data.

Since the first element in the 2*3 sub convolutional kernel is located in row 4 and column 1 of the convolutional kernel, the first element in the first sub input data corresponding to the 2*3 sub convolutional kernel is located in row 4 and column 1 of the input data, and the elements included in this first sub input data are composed of the elements that may be traversed by the 3*2 sub convolutional kernel when the 5*5 convolutional kernel traverses the elements of the 8*8 input data. In other words, the first sub input data corresponding to the 3*2 sub convolutional kernel is 5*6 first sub input data composed of elements of rows 4-8 and columns 1-6 of the input data.

Since the first element in a 2*2 sub convolutional kernel is located in row 4 and column 4 of the convolutional kernel, the first element in the first sub input data corresponding to the 2*2 sub convolutional kernel is located in row 4 and column 4 of the input data, and the elements included in this first sub input data are composed of the elements that may be traversed by the 2*3 sub convolutional kernel when the 5*5 convolutional kernel traverses the elements of the 8*8 input data. In other words, the first sub input data corresponding to the 2*3 sub convolutional kernel is 5*5 first sub input data composed of elements of rows 4-8 and columns 4-8 of the input data.

After the first sub input data that uniquely corresponds to the sub convolutional kernel is determined, one or more pieces of target sub input data with the size less than or equal to 4*4 corresponding to the sub convolutional kernel are further determined based on the first sub input data corresponding to the sub convolutional kernel. If the size of the first sub input data corresponding to the sub convolutional kernel is larger than 4*4, the plurality of pieces of target sub input data with the size less than or equal to 4*4 are obtained by splitting the first sub input data.

The splitting principle for the first sub input data with the size greater than 4*4 is that a convolution result of the sub convolutional kernel and the plurality of pieces of target sub input data with the size less than or equal to 4*4 obtained after the splitting is the same as a convolution result of the sub convolutional kernel and the first sub input data with the size greater than 4*4 before the splitting. Specific splitting methods may include a variety of ways, and the present disclosure does not specifically limit this.

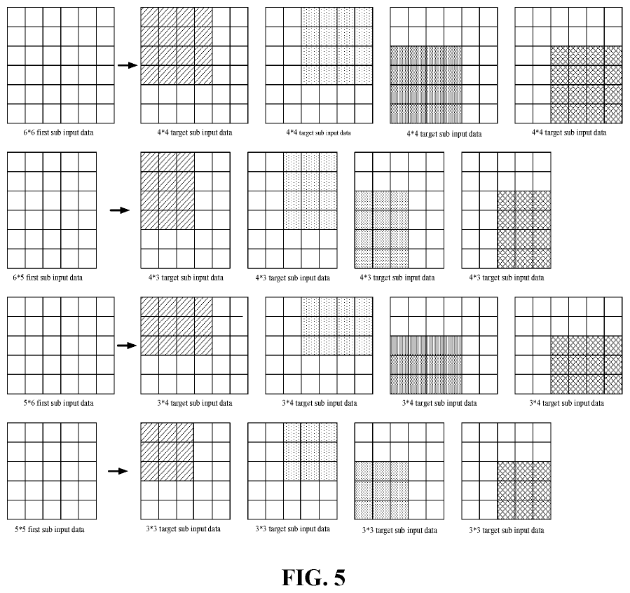

Still taking FIG. 4 as an example, one or more pieces of target sub input data with the size less than or equal to 4*4 corresponding to the sub convolutional kernel are determined based on the first sub input data that uniquely corresponds to the sub convolutional kernel shown in FIG. 4. FIG. 5 illustrates a diagram of a plurality of pieces of target sub input data with a size less than or equal to 4*4 corresponding to a sub convolutional kernel obtained based on first sub input data corresponding to the sub convolutional kernel shown in FIG. 4 according to an embodiment of the present disclosure.

As shown in FIG. 5, a size of first sub input data corresponding to a 3*3 sub convolutional kernel is 6*6, which is larger than 4*4. 6*6 first sub input data is split to obtain four pieces of 4*4 target sub input data corresponding to the 3*3 sub convolutional kernel shown in FIG. 5: 4*4 target sub input data composed of elements of rows 1-4 and columns 1-4 of the 6*6 first sub input data, 4*4 target sub input data composed of elements of rows 1-4 and columns 3-6 of the 6*6 first sub input data, 4*4 target sub input data composed of elements of rows 3-6 and columns 1-4 of the 6*6 first sub input data, and 4*4 target sub input data composed of elements of rows 3-6 and columns 3-6 of the 6*6 first sub input data.

As shown in FIG. 5, a size of first sub input data corresponding to a 3*2 sub convolutional kernel is 6*5, which is larger than 4*4. 6*5 first sub input data is split to obtain four pieces of target sub input data corresponding to the 3*2 sub convolutional kernel shown in FIG. 5: 4*3 target sub input data composed of elements of rows 1-4 and columns 1-3 of the 6*5 first sub input data, 4*3 target sub input data composed of elements of rows 1-4 and columns 3-5 of the 6*5 first sub input data, 4*3 target sub input data composed of elements of rows 3-6 and columns 1-3 of the 6*5 first sub input data, and 4*3 target sub input data composed of elements of rows 3-6 and columns 3-5 of the 6*5 first sub input data.

As shown in FIG. 5, a size of first sub input data corresponding to a 2*3 sub convolutional kernel is 5*6, which is larger than 4*4. 5*6 first sub input data is split to obtain four pieces of target sub input data corresponding to the 2*3 sub convolutional kernel shown in FIG. 5: 3*4 target sub input data composed of elements of rows 1-3 and columns 1-4 of the 5*6 first sub input data, 3*4 target sub input data composed of elements of rows 1-3 and columns 1-4 of the 5*6 first sub input data, 3*4 target sub input data composed of elements of rows 3-5 and columns 1-4 of the 5*6 first sub input data, and 3*4 target sub input data composed of elements of rows 3-5 and columns 3-6 of the 5*6 first sub input data.

As shown in FIG. 5, a size of first sub input data corresponding to a 2*2 sub convolutional kernel is 5*5, which is larger than 4*4. 5*5 first sub input data is split to obtain four pieces of target sub input data corresponding to the 2*2 sub convolutional kernel shown in FIG. 5: 3*3 target sub input data composed of elements of rows 1-3 and columns 1-3 of the 5*5 first sub input data, 3*3 target sub input data composed of elements of rows 1-3 and columns 3-5 of the 5*5 first sub input data, 3*3 target sub input data composed of elements of rows 3-5 and columns 1-3 of the 5*5 first sub input data, and 3*3 target sub input data composed of elements of rows 3-5 and columns 3-5 of the 5*5 first sub input data.

FIG. 5 only shows one kind of splitting example of splitting the first sub input data with the size greater than 4*4 into the plurality of pieces of target sub input data with the size less than or equal to 4*4, and does not constitute a limitation on the splitting method. As long as the above splitting principle for the first sub input data with the size greater than 4*4 is satisfied, there may be other splitting methods, and the present disclosure does not make any specific limitation on this.

After the convolutional kernel is split into the plurality of sub convolutional kernels with the size less than or equal to 3*3, and the input data is split into the plurality of pieces of target sub input data with the size less than or equal to 4*4: for any one of the sub convolutional kernels, a winograd convolution operation is performed on the sub convolutional kernel and one or more pieces of target sub input data corresponding to the sub convolutional kernel to obtain a convolution result corresponding to the sub convolutional kernel; and then a summation operation is performed on convolution results corresponding to the plurality of sub convolutional kernels to obtain a convolution result of the convolutional kernel and the input data.

The following describes in detail a winograd convolution operation of the sub convolutional kernel with the size less than or equal to 3*3 and corresponding target sub input data with the size less than or equal to 4*4 through a shift and a summation computation.

In a possible implementation, for any one of the sub convolutional kernels, performing the winograd convolution operation on the sub convolutional kernel and the corresponding target sub input data to obtain the convolution result corresponding to the sub convolutional kernel includes: splitting a winograd forward transformation of the target sub input data into the summation computation and performing the summation computation to obtain a winograd forward transformation result of the target sub input data; splitting a winograd forward transformation of the sub convolutional kernel into the summation computation and performing the summation computation to obtain a winograd forward transformation result of the sub convolutional kernel; performing an element-wise multiplication between the winograd forward transformation result of the target sub input data and the winograd forward transformation result of the sub convolutional kernel to obtain an element-wise multiplication result; splitting a winograd backward transformation of the element-wise multiplication result into the summation computation and performing the summation computation to obtain the convolution result of the sub convolutional kernel.

In a possible implementation, splitting the winograd forward transformation of the target sub input data into the summation computation and performing the summation computation to obtain the winograd forward transformation result of the target sub input data include: splitting the target sub input data into a plurality of first sub-tensors, and performing the winograd forward transformation and the summation computation on the plurality of first sub-tensors to obtain the winograd forward transformation result of the target sub input data, where the number of the plurality of first sub-tensors is the same as the number of non-zero elements in the target sub input data, and one element of at least one first sub-tensor in the plurality of first sub-tensors is the same as an element at a corresponding position in the target sub input data, and all other elements are 0.

For example, 4*4 target sub input data d_{4*4} is a 4*4 matrix including 16 elements, which is expressed as follows:

$${d}_{4 * 4} = [ \begin{matrix}{d}_{00} & {d}_{01} & {d}_{02} & {d}_{03} \\ {d}_{10} & {d}_{11} & {d}_{12} & {d}_{13} \\ {d}_{20} & {d}_{21} & {d}_{22} & {d}_{23} \\ {d}_{30} & {d}_{31} & {d}_{32} & {d}_{33}\end{matrix} ] .$$

If all 16 elements included in the target sub input data d_{4*4} are non-zero elements, the target sub input data d_{4*4} may be split into 16 first sub-tensors, including:

$${d}_{00} = [ \begin{matrix}{d}_{00} & 0 & 0 & 0 \\ 0 & 0 & 0 & 0 \\ 0 & 0 & 0 & 0 \\ 0 & 0 & 0 & 0\end{matrix} ] , {d}_{01} = [ \begin{matrix}0 & {d}_{01} & 0 & 0 \\ 0 & 0 & 0 & 0 \\ 0 & 0 & 0 & 0 \\ 0 & 0 & 0 & 0\end{matrix} ] , {d}_{02} = [ \begin{matrix}0 & 0 & {d}_{02} & 0 \\ 0 & 0 & 0 & 0 \\ 0 & 0 & 0 & 0 \\ 0 & 0 & 0 & 0\end{matrix} ] , {d}_{03} = [ \begin{matrix}0 & 0 & 0 & {d}_{03} \\ 0 & 0 & 0 & 0 \\ 0 & 0 & 0 & 0 \\ 0 & 0 & 0 & 0\end{matrix} ] , … , {d}_{33} = [ \begin{matrix}0 & 0 & 0 & 0 \\ 0 & 0 & 0 & 0 \\ 0 & 0 & 0 & 0 \\ 0 & 0 & 0 & {d}_{33}\end{matrix} ] .$$

One element in the first sub-tensor is the same as the element at the corresponding position in the target sub input data, and all other elements are 0, which means: taking a first sub-tensor d₀₀ as an example, an element of row 1 and column 1 of d₀₀ is the same as an element of row 1 and column 1 of the target sub input data, and all other elements at other positions of d₀₀ are 0. Other first sub-tensors have the same properties.

It should be noted that the above splitting method shows only some examples of the present disclosure and does not limit the present disclosure in any way. For example, if there are elements with a value of 0, the number of the first sub-tensor obtained after splitting is the same as the number of non-zero elements in the target sub-data. In other words, the number of the first sub-tensor obtained after splitting is less than the number of elements in the target sub input data.

In a possible implementation, performing the winograd forward transformation and the summation computation on the plurality of first sub-tensors to obtain the winograd forward transformation result of the target sub input data includes: obtaining a winograd forward transformation result of a first meta-tensor corresponding to a first sub-tensor, where for the first meta-tensor corresponding to the first sub-tensor, an element value at a first position in the first meta-tensor is 1, where the first position in the first meta-tensor is the same as a position of a non-zero element in the first sub-tensor; multiplying a non-zero element value in the first sub-tensor, as a coefficient, by the winograd forward transformation result of a corresponding first meta-tensor to obtain the winograd forward transformation result of the first sub-tensor; and summing winograd forward transformation results of the plurality of first sub-tensors to obtain the winograd forward transformation result of the target sub input data.

Taking the above first sub-tensor doo as an example, a first meta-tensor corresponding to d₀₀ may be

$$[ \begin{matrix}1 & 0 & 0 & 0 \\ 0 & 0 & 0 & 0 \\ 0 & 0 & 0 & 0 \\ 0 & 0 & 0 & 0\end{matrix} ] .$$

In other words, the first meta-tensor is formed by extracting the non-zero element value of the first sub-tensor, and the non-zero element value may be used as a coefficient of the first meta-tensor.

In a possible implementation, the winograd forward transformation result of the first sub-tensor corresponding to the first sub-tensor is obtained in advance by the following processes: for the first sub-tensor, the winograd forward transformation result of the first meta-tensor is obtained by multiplying a left side of the first meta-tensor corresponding to the first sub-tensor by a forward transformation left-multiply matrix and by multiplying a right side of the first meta-tensor corresponding to the first sub-tensor by a forward transformation right-multiply matrix.

For target sub input data with different sizes, a corresponding forward left-multiply matrix and a corresponding forward right-multiply matrix are also determined. For example, for target sub input data with a size of 4*4, the corresponding forward transformation left-multiply matrix is

$$[ \begin{matrix}1 & 0 & - 1 & 0 \\ 0 & 1 & 1 & 0 \\ 0 & - 1 & 1 & 0 \\ 0 & 1 & 0 & - 1\end{matrix} ] ,$$

and the corresponding forward transformation right-multiply matrix is

$$[ \begin{matrix}1 & 0 & 0 & 0 \\ 0 & 1 & - 1 & 1 \\ - 1 & 1 & 1 & 0 \\ 0 & 0 & 0 & - 1\end{matrix} ] ;$$

for target sub input data with a size of 4*3, the corresponding forward transformation left-multiply matrix is

$$[ \begin{matrix}1 & 0 & - 1 & 0 \\ 0 & 1 & 1 & 0 \\ 0 & - 1 & 1 & 0 \\ 0 & 1 & 0 & - 1\end{matrix} ] ,$$

and the corresponding forward transformation right-multiply matrix is

$$[ \begin{matrix}1 & 0 & 0 \\ - 1 & 1 & - 1 \\ 0 & 0 & 1\end{matrix} ] ;$$

for target sub input data with a size of 3*4, the corresponding forward transformation left-multiply matrix is

$$[ \begin{matrix}1 & - 1 & 0 \\ 0 & 1 & 0 \\ 0 & - 1 & 1\end{matrix} ]$$

and the corresponding forward transformation right-multiply matrix is

$$[ \begin{matrix}1 & 0 & 0 & 0 \\ 0 & 1 & - 1 & 1 \\ - 1 & 1 & 1 & 0 \\ 0 & 0 & 0 & - 1\end{matrix} ] ;$$

for target sub input data with a size of 3*3, the corresponding forward transformation left-multiply matrix is

$$[ \begin{matrix}1 & - 1 & 0 \\ 0 & 1 & 0 \\ 0 & - 1 & 1\end{matrix} ] ,$$

and the corresponding forward transformation right-multiply matrix is

$$[ \begin{matrix}1 & 0 & 0 \\ - 1 & 1 & - 1 \\ 0 & 0 & 1\end{matrix} ] .$$

Therefore, the winograd forward transformation result of the first meta-tensor may be calculated in advance. For example, taking the above first sub-tensor doo as an example, the corresponding winograd forward transformation result of the first meta-tensor is:

$$[ \begin{matrix}1 & 0 & - 1 & 0 \\ 0 & 1 & 1 & 0 \\ 0 & - 1 & 1 & 0 \\ 0 & 1 & 0 & - 1\end{matrix} ] [ \begin{matrix}1 & 0 & 0 & 0 \\ 0 & 0 & 0 & 0 \\ 0 & 0 & 0 & 0 \\ 0 & 0 & 0 & 0\end{matrix} ] [ \begin{matrix}1 & 0 & 0 & 0 \\ 0 & 1 & - 1 & 1 \\ - 1 & 1 & 1 & 0 \\ 0 & 0 & 0 & - 1\end{matrix} ] = [ \begin{matrix}1 & 0 & 0 & 0 \\ 0 & 0 & 0 & 0 \\ 0 & 0 & 0 & 0 \\ 0 & 0 & 0 & 0\end{matrix} ] .$$

For example, taking the first sub-tensor do above as an example, the corresponding winograd forward transformation result of the first meta-tensor

$$[ \begin{matrix}0 & 1 & 0 & 0 \\ 0 & 0 & 0 & 0 \\ 0 & 0 & 0 & 0 \\ 0 & 0 & 0 & 0\end{matrix} ]$$

is:

$$[ \begin{matrix}1 & 0 & - 1 & 0 \\ 0 & 1 & 1 & 0 \\ 0 & - 1 & 1 & 0 \\ 0 & 1 & 0 & - 1\end{matrix} ] [ \begin{matrix}0 & 1 & 0 & 0 \\ 0 & 0 & 0 & 0 \\ 0 & 0 & 0 & 0 \\ 0 & 0 & 0 & 0\end{matrix} ] [ \begin{matrix}1 & 0 & 0 & 0 \\ 0 & 1 & - 1 & 1 \\ - 1 & 1 & 1 & 0 \\ 0 & 0 & 0 & - 1\end{matrix} ] = [ \begin{matrix}0 & 1 & - 1 & 1 \\ 0 & 0 & 0 & 0 \\ 0 & 0 & 0 & 0 \\ 0 & 0 & 0 & 0\end{matrix} ] .$$

Since the size of the target sub input data obtained after splitting is less than or equal to 4*4, according to the above forward transformation left-multiply matrix and forward transformation right-multiply matrix corresponding to the target sub input data with different sizes, it is known that if the size of the target sub input data is less than or equal to 4*4, element values in the corresponding forward transformation left-multiply matrix and the corresponding forward transformation right-multiply matrix are 0 and ±1, and element values of the first meta-tensor are 0 and 1, and elements of the winograd forward transformation result of the first meta-tensor are 0 and ±1. Therefore, a matrix multiplication operation of the target sub input data may be split into an addition operation.

Calculating the winograd forward transformation result of the first meta-tensor involves many multiplication computations. According to the present disclosure, winograd forward transformation results of first meta-tensors with different sizes may be calculated in advance to be stored, so that the results may be directly obtained in a practical computation process without repeated computations, thereby reducing calculation time and saving calculation resources.

After the winograd forward transformation result of the first meta-tensor corresponding to the first sub-tensor is obtained, the winograd forward transformation result of the first sub-tensor may be obtained by multiplying the non-zero element value of the first sub-tensor by the winograd forward transformation result of the corresponding first meta-tensor.

For example, taking the first sub-tensor doo above as an example, the corresponding winograd forward transformation result is doo

$${d}_{00} [ \begin{matrix}1 & 0 & 0 & 0 \\ 0 & 0 & 0 & 0 \\ 0 & 0 & 0 & 0 \\ 0 & 0 & 0 & 0\end{matrix} ] .$$

Taking the first sub-tensor do, above as an example, the corresponding winograd forward transformation result is

$${d}_{01} [ \begin{matrix}0 & 1 & - 1 & 1 \\ 0 & 0 & 0 & 0 \\ 0 & 0 & 0 & 0 \\ 0 & 0 & 0 & 0\end{matrix} ] .$$

Through the above process, the winograd forward transformation result of the first sub-tensor may be obtained. By summing the winograd forward transformation results of the plurality of first sub-tensors, the winograd forward transformation result of the target sub input data may be obtained.

$${B}^{T} {d}_{4 ⋆ 4} B = {d}_{00} [ \begin{matrix}1 & 0 & 0 & 0 \\ 0 & 0 & 0 & 0 \\ 0 & 0 & 0 & 0 \\ 0 & 0 & 0 & 0\end{matrix} ] + {d}_{01} [ \begin{matrix}0 & 1 & - 1 & 1 \\ 0 & 0 & 0 & 0 \\ 0 & 0 & 0 & 0 \\ 0 & 0 & 0 & 0\end{matrix} ] + … + {d}_{33} [ \begin{matrix}0 & 0 & 0 & 0 \\ 0 & 0 & 0 & 0 \\ 0 & 0 & 0 & 0 \\ 0 & 0 & 0 & 0\end{matrix} ] .$$

In a possible implementation, splitting the winograd forward transformation of the sub convolutional kernel into the summation computation and performing the summation computation to obtain the winograd forward transformation result of the sub convolutional kernel include: splitting the sub convolutional kernel into a plurality of second sub-tensors, and performing the winograd forward transformation and the summation computation on the plurality of second sub-tensors to obtain the winograd forward transformation result of the sub convolutional kernel, where the number of the second sub-tensors is the same as the number of the non-zero elements in the sub convolutional kernel, and one element of at least one second sub-tensor in the plurality of the second sub-tensors is the same as the element at the corresponding position in the sub convolutional kernel, and all other elements are 0.

For example, a 3*3 sub convolutional kernel g_{3*3} is a 3*3 matrix including 9 elements, which is represented as:

$${g}_{3 ⋆ 3} = [ \begin{matrix}{g}_{00} & {g}_{01} & {g}_{02} \\ {g}_{10} & {g}_{11} & {g}_{12} \\ {g}_{20} & {g}_{21} & {g}_{22}\end{matrix} ] .$$

If all 9 elements included in the sub convolutional kernel g_{3*3} are the non-zero elements, the sub convolutional kernel g_{3*3} may be split into 9 second sub-tensors, which are:

$${g}_{00} = [ \begin{matrix}{g}_{00} & 0 & 0 \\ 0 & 0 & 0 \\ 0 & 0 & 0\end{matrix} ] , {g}_{01} = [ \begin{matrix}0 & {g}_{01} & 0 \\ 0 & 0 & 0 \\ 0 & 0 & 0\end{matrix} ] , {g}_{02} = [ \begin{matrix}0 & 0 & {g}_{02} \\ 0 & 0 & 0 \\ 0 & 0 & 0\end{matrix} ] , … … , {g}_{22} = [ \begin{matrix}0 & 0 & 0 \\ 0 & 0 & 0 \\ 0 & 0 & {g}_{22}\end{matrix} ] .$$

One element in the second sub-tensor is the same as the element at the corresponding position in the sub convolutional kernel, and all other elements are 0, which means: taking a second sub-tensor goo as an example, an element of row 1 and column 1 of goo is the same as an element of row 1 and column 1 of the sub convolutional kernel, and all other elements of other positions of goo are 0. Other second sub-tensors have the same properties.

It should be noted that the above splitting method only shows some examples of the present disclosure and does not limit the present disclosure in any way. For example, if there are the elements with the value of 0, the number of second sub-tensors obtained after splitting is the same as the number of the non-zero elements in the sub convolutional kernel. In other words, the number of the second sub-tensors obtained after splitting is less than the number of the elements in the sub convolutional kernel.

In a possible implementation, performing the winograd forward transformation and the summation computation on the plurality of second sub-tensors to obtain the winograd forward transformation result of the sub convolution includes: obtaining a winograd forward transformation result of a second meta-tensor corresponding to a second sub-tensor, where for the second meta-tensor corresponding to the second sub-tensor, an element value at a second position in the second meta-tensor is 1, where the second position in the second meta-tensor is the same as the position of the non-zero element in the second sub-tensor; multiplying setting the non-zero element value in the second sub-tensor, as the coefficient, by the winograd forward transformation result of a corresponding second meta-tensor to obtain the winograd forward transformation result of the second sub-tensor; and summing winograd forward transformation results of the plurality of second sub-tensors to obtain the winograd forward transformation result of the sub convolution kernel.

Taking the second sub-tensor goo above as an example, the second meta-tensor corresponding to g₀₀ may be

$$[ \begin{matrix}1 & 0 & 0 \\ 0 & 0 & 0 \\ 0 & 0 & 0\end{matrix} ] .$$

In other words, the second meta-tensor is formed by extracting the non-zero element value from the second sub-tensor, and the non-zero element value may be used as a coefficient of the first meta-tensor.

In a possible implementation, the winograd forward transformation result of the second meta-tensor corresponding to the second sub-tensor is obtained in advance by the following processes: for the second sub-tensor, the winograd forward transformation result of the second meta-tensor is obtained by multiplying a left side of the second meta-tensor corresponding to the second sub-tensor by the forward transformation left-multiply matrix and by multiplying a right side of the second meta-tensor corresponding to the second sub-tensor by the forward transformation right-multiply matrix.

For sub convolutional kernels with different sizes, the corresponding forward transformation left-multiply matrix and the corresponding forward transformation right-multiply matrix are also determined. For example, for the sub convolutional kernel with the size of 3*3, the corresponding forward transformation left-multiply matrix is

$$[ \begin{matrix}1 & 0 & 0 \\ 1 & 1 & 1 \\ 1 & - 1 & 1 \\ 0 & 0 & 1\end{matrix} ] ,$$

and the corresponding forward transformation right-multiply matrix is

$$[ \begin{matrix}1 & 1 & 1 & 0 \\ 0 & 1 & - 1 & 0 \\ 0 & 1 & 1 & 1\end{matrix} ] .$$

For the sub convolutional kernel with the size of 3*2, the corresponding forward transformation left-multiply matrix is

$$[ \begin{matrix}1 & 0 & 0 \\ 1 & 1 & 1 \\ 1 & - 1 & 1 \\ 0 & 0 & 1\end{matrix} ] ,$$

and the corresponding forward transformation right-multiply matrix is

$$[ \begin{matrix}1 & 1 & 0 \\ 0 & 1 & 1\end{matrix} ] .$$

For the sub convolutional kernel with the size of 2*3, the corresponding forward transformation left-multiply matrix is

$$[ \begin{matrix}1 & 0 \\ 1 & 1 \\ 0 & 1\end{matrix} ] ,$$

and the corresponding forward transformation right-multiply matrix is

$$[ \begin{matrix}1 & 1 & 1 & 0 \\ 0 & 1 & - 1 & 0 \\ 0 & 1 & 1 & 1\end{matrix} ] .$$

For the sub convolutional kernel with the size of 2*2, the corresponding forward transformation left-multiply matrix is

$$[ \begin{matrix}1 & 0 \\ 1 & 1 \\ 0 & 1\end{matrix} ] ,$$

and the corresponding forward transformation right-multiply matrix is

$$[ \begin{matrix}1 & 1 & 0 \\ 0 & 1 & 1\end{matrix} ] .$$

Therefore, the winograd forward transformation result of the second meta-tensor may be calculated in advance. For example, taking the second sub-tensor go above as an example, the corresponding winograd forward transformation result of the second meta-tensor is:

$$[ \begin{matrix}1 & 0 & 0 \\ 1 & 1 & 1 \\ 1 & - 1 & 1 \\ 0 & 0 & 1\end{matrix} ] [ \begin{matrix}1 & 0 & 0 \\ 0 & 0 & 0 \\ 0 & 0 & 0\end{matrix} ] [ \begin{matrix}1 & 1 & 1 & 0 \\ 0 & 1 & - 1 & 0 \\ 0 & 1 & 1 & 1\end{matrix} ] = [ \begin{matrix}1 & 1 & 1 & 0 \\ 1 & 1 & 1 & 0 \\ 1 & 1 & 1 & 0 \\ 0 & 0 & 0 & 0\end{matrix} ] .$$

Since the size of the sub convolutional kernel obtained after splitting is less than or equal to 3*3, according to the forward transformation left-multiply matrix and the forward transformation right-multiply matrix corresponding to the sub convolutional kernels with different sizes mentioned above, if the size of the sub convolutional kernel is less than or equal to 3*3, the element values of the corresponding forward transformation left-multiply matrix and the corresponding forward transformation right-multiply matrix are 0 and ±1, and the element values of the second meta-tensor are 0 and 1, and the elements of the winograd forward transformation result of the second meta-tensor are 0 and ±1. Therefore, the matrix multiplication operation of the sub convolutional kernel may be split into the addition operation.

Calculating the winograd forward transformation result of the second meta-tensor involves many multiplication computations. According to the present disclosure, the winograd forward transformation results of the second meta-tensors with different sizes may be calculated in advance to be stored, so that the results may be obtained directly during the practical computation process without repeated computations, thereby reducing the calculation time and saving the calculation resources.

After the winograd forward transformation result of the second meta-tensor corresponding to the second sub-tensor is obtained, the winograd forward transformation result of the second sub-tensor may be obtained by multiplying the non-zero element value of the second sub-tensor by the winograd forward transformation result of the second meta-tensor corresponding to the second sub-tensor.

For example, taking the above second sub-tensor goo as an example, the corresponding winograd forward transformation result is:

$${g}_{00} [ \begin{matrix}1 & 1 & 1 & 0 \\ 1 & 1 & 1 & 0 \\ 1 & 1 & 1 & 0 \\ 0 & 0 & 0 & 0\end{matrix} ] .$$

Through the above process, the winograd forward transformation of the second sub-tensor is obtained, and the winograd forward transformation result of the sub convolutional kernel is obtained by summing the winograd forward transformation results of the plurality of second sub-tensors.

$${G}^{T} {g}_{3 * 3} G = {g}_{00} [ \begin{matrix}1 & 1 & 1 & 0 \\ 1 & 1 & 1 & 0 \\ 1 & 1 & 1 & 0 \\ 0 & 0 & 0 & 0\end{matrix} ] + {g}_{01} [ \begin{matrix}0 & 1 & - 1 & 0 \\ 0 & 1 & 1 & 1 \\ 0 & 1 & 1 & 1 \\ 0 & 0 & 0 & 0\end{matrix} ] + … + {g}_{22} [ \begin{matrix}0 & 0 & 0 & 0 \\ 0 & 1 & 1 & 1 \\ 0 & 1 & 1 & 1 \\ 0 & 1 & 1 & 1\end{matrix} ] .$$

The element-wise multiplication of the winograd forward transformation result of the target sub input data and the winograd forward transformation result of the sub convolutional kernel may be performed to obtain the element-wise multiplication result. The element-wise multiplication means multiplying data at corresponding positions of two tensors, and the data obtained is taken as a value at the corresponding position in the element-wise multiplication result.

For example, a winograd forward transformation result B^{T}d_{4*4}B of the target sub input data d_{4*4} may be expressed as:

$${D}_{4 * 4} = [ \begin{matrix}{D}_{00} & {D}_{01} & {D}_{02} & {D}_{03} \\ {D}_{10} & {D}_{11} & {D}_{12} & {D}_{13} \\ {D}_{20} & {D}_{21} & {D}_{22} & {D}_{23} \\ {D}_{30} & {D}_{31} & {D}_{32} & {D}_{33}\end{matrix} ] .$$

A winograd forward transformation result G^{T}g_{3*3}G of the sub convolutional kernel g_{3*3} may be expressed as:

$${G}_{4 * 4} = [ \begin{matrix}{G}_{00} & {G}_{01} & {G}_{02} & {G}_{03} \\ {G}_{10} & {G}_{11} & {G}_{12} & {G}_{13} \\ {G}_{20} & {G}_{21} & {G}_{22} & {G}_{23} \\ {G}_{30} & {G}_{31} & {G}_{32} & {G}_{33}\end{matrix} ] .$$

Then an element-wise multiplication result G₄⊙D_{4*4} may be expressed as:

$${C}_{{4}^{*} 4} = [ \begin{matrix}{G}_{00} ⨯ {D}_{00} & {G}_{01} ⨯ {D}_{01} & {G}_{02} ⨯ {D}_{02} & {G}_{03} ⨯ {D}_{03} \\ {G}_{10} ⨯ {D}_{10} & {G}_{11} ⨯ {D}_{11} & {G}_{12} ⨯ {D}_{12} & {G}_{13} ⨯ {D}_{13} \\ {G}_{20} ⨯ {D}_{20} & {G}_{21} ⨯ {D}_{21} & {G}_{22} ⨯ {D}_{22} & {G}_{23} ⨯ {D}_{23} \\ {G}_{30} ⨯ {D}_{30} & {G}_{31} ⨯ {D}_{31} & {G}_{32} ⨯ {D}_{32} & {G}_{33} ⨯ {D}_{33}\end{matrix} ] = \\ [ \begin{matrix}{C}_{00} & {C}_{01} & {C}_{02} & {C}_{03} \\ {C}_{10} & {C}_{11} & {C}_{12} & {C}_{13} \\ {C}_{20} & {C}_{21} & {C}_{22} & {C}_{23} \\ {C}_{30} & {C}_{31} & {C}_{32} & {C}_{33}\end{matrix} ] .$$

In a possible implementation, splitting the winograd backward transformation of the element-wise multiplication result into the summation computation and performing the summation computation to obtain the convolution result corresponding to the sub convolutional kernel include: splitting the element-wise multiplication result into a plurality of third sub-tensors, and performing the winograd backward transformation and the summation computation on the plurality of third sub-tensors to obtain the convolution result corresponding to the sub convolutional kernel, where the number of the plurality of third sub-tensors is the same as the number of the non-zero elements in the element-wise multiplication result, and one element of at least one third sub-tensor in the plurality of third sub-tensors is the same as the element at the corresponding position in the element-wise multiplication result, and all other elements are 0.

Taking an element-wise multiplication result C_{4*4} as an example,

$${C}_{{4}^{*} 4} = [ \begin{matrix}{C}_{00} & {C}_{01} & {C}_{02} & {C}_{03} \\ {C}_{10} & {C}_{11} & {C}_{12} & {C}_{13} \\ {C}_{20} & {C}_{21} & {C}_{22} & {C}_{23} \\ {C}_{30} & {C}_{31} & {C}_{32} & {C}_{33}\end{matrix} ] ,$$

which consists of 16 elements, and the element-wise multiplication result is split into the plurality of third sub-tensors, which are:

$${C}_{00} = [ \begin{matrix}{C}_{00} & 0 & 0 & 0 \\ 0 & 0 & 0 & 0 \\ 0 & 0 & 0 & 0 \\ 0 & 0 & 0 & 0\end{matrix} ] , {C}_{01} = [ \begin{matrix}0 & {C}_{01} & 0 & 0 \\ 0 & 0 & 0 & 0 \\ 0 & 0 & 0 & 0 \\ 0 & 0 & 0 & 0\end{matrix} ] , {C}_{02} = [ \begin{matrix}0 & 0 & {C}_{02} & 0 \\ 0 & 0 & 0 & 0 \\ 0 & 0 & 0 & 0 \\ 0 & 0 & 0 & 0\end{matrix} ] , {C}_{03} = [ \begin{matrix}0 & 0 & 0 & {C}_{03} \\ 0 & 0 & 0 & 0 \\ 0 & 0 & 0 & 0 \\ 0 & 0 & 0 & 0\end{matrix} ] , …… , {C}_{33} = [ \begin{matrix}0 & 0 & 0 & 0 \\ 0 & 0 & 0 & 0 \\ 0 & 0 & 0 & 0 \\ 0 & 0 & 0 & {C}_{33}\end{matrix} ] .$$

In a possible implementation, performing the winograd backward transformation and the summation computation on the plurality of third sub-tensors backward transformation to obtain the convolution result corresponding to the sub convolutional kernel includes: obtaining a winograd backward transformation result of a third meta-tensor corresponding to a third meta-tensor, where for the third meta-tensor corresponding to the third sub-tensor, an element value at a third position in the third meta-tensor is 1, where the third position in the second meta-tensor is the same as the position of the non-zero element in the second sub-tensor; multiplying the non-zero element value in the third sub-tensor, as the coefficient, by backward transformation the winograd backward transformation result of a corresponding third meta-tensor to obtain the winograd backward transformation result of the third sub-tensor; and summing winograd backward transformation results of the plurality of third sub-tensors to obtain the convolution result corresponding to the sub convolutional kernel.

A determining method for the third meta-tensor corresponding to the third meta-tensor is the same as that of the first meta-tensor above, which will not be repeated here.

In a possible implementation, the winograd backward transformation result of the third meta-tensor is obtained in advance by the following processes: for the third sub-tensor, the winograd backward transformation result of the third meta-tensor is obtained by multiplying a left side of the third meta-tensor corresponding to the third sub-tensor by an backward transformation left-multiply matrix and by multiplying a right side of the third meta-tensor corresponding to the third sub-tensor by an backward transformation right-multiply matrix.

A corresponding backward transformation left-multiply matrix and a corresponding backward transformation right-multiply matrix are also determined for element-wise multiplication results with different sizes. Therefore, the winograd backward transformation result of the third meta-tensor may be calculated in advance.

Taking the above element-wise multiplication result C_{4*4} as an example, the corresponding backward transformation left-multiply matrix is

$$[ \begin{matrix}1 & 1 / 2 & 1 / 2 & 0 \\ 0 & 1 / 2 & - 1 / 2 & - 1\end{matrix} ] ,$$

and the corresponding backward transformation right-multiply matrix is

$$[ \begin{matrix}1 & 0 \\ 1 / 2 & 1 / 2 \\ 1 / 2 & - 1 / 2 \\ 0 & - 1\end{matrix} ]$$

for an element-wise multiplication result with a size of 4*4.

Since the size of the target sub input data obtained after splitting is less than or equal to 4*4 and the size of the sub convolutional kernel obtained after splitting is less than or equal to 3*3, a size of the element-wise multiplication result of the winograd forward transformation result of the target sub input data and the winograd forward transformation result of the sub convolutional kernel is less than or equal to 4*4. Since if the size of the element-wise multiplication result is less than or equal to 4*4, element values of the corresponding backward transformation left-multiply matrix and the corresponding backward transformation right-multiply matrix are 0, ±½, and ±1, element values of the third meta-tensor are 0 and 1, and elements of the winograd forward transformation result of the third meta-tensor are 0 and ±1. Therefore, a matrix multiplication operation on the element-wise multiplication result may be split into a shift (for fractions) and an addition operation. A specific splitting process is similar to a process of splitting the winograd forward transformation of the target sub input data into the addition operation and a process of splitting the winograd forward transformation of the sub convolutional kernel into the addition operation, which will not be repeated here.

By performing the above splitting and summation processes, the convolution result of the sub convolutional kernel and the corresponding target sub input data is obtained, and then the convolution result of the sub convolutional kernel and uniquely corresponding first sub input data is obtained. By summing convolution results of the sub convolutional kernels and the uniquely corresponding first sub input data, the convolution result of the convolutional kernel and the input data may be obtained.

The convolutional kernel with the size greater than 3*3 is split into the plurality of sub convolutional kernels with the size less than or equal to 3*3, and the input data is split into the plurality of pieces of target sub input data with the size less than or equal to 4*4 according to the position distributions of the plurality of sub convolutional kernels in the convolutional kernel, where the sub convolutional kernel corresponds to one or more pieces of target sub input data; then for any one of the sub convolutional kernels, the winograd convolution operation is performed on the sub convolutional kernel and the corresponding target sub input data to obtain the convolution of the sub convolutional kernel, so that the summation operation is performed on the convolution results corresponding to the plurality of sub convolutional kernels to obtain the convolution result of the convolutional kernel and the input data. By splitting the convolutional kernel into the convolution kernel with the size less than or equal to 3*3 and by splitting the input data into the input data with the size less than or equal to 4*4, since there is no fractional number in a transformation matrix corresponding to the convolutional kernel with the size less than or equal to 3*3 and the input data with the size less than or equal to 4*4, multiplication computations are not required during the winograd convolution operation, and only through the shift and the summation computation, the convolution result is obtained, thereby reducing calculation amount, saving calculation time, and reducing power consumption.

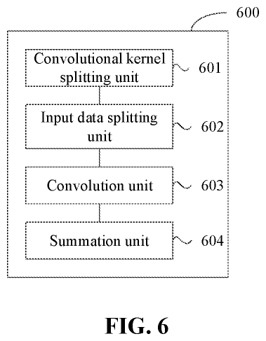

FIG. 6 illustrates a schematic structural diagram of a data processing apparatus according to an embodiment of the present disclosure. As shown in FIG. 6, an apparatus 600 includes:

a convolutional kernel splitting unit 601 configured to split a convolutional kernel with a size greater than 3*3 into a plurality of sub convolutional kernels with a size less than or equal to 3*3;

an input data splitting unit 602 configured to split input data into a plurality of pieces of target sub input data with a size less than or equal to 4*4 according to position distributions of the plurality of sub convolutional kernels in the convolutional kernel, where a sub convolutional kernel corresponds to one or more pieces of target sub input data;

a convolution unit 603 configured to, for any one of the sub convolutional kernels, perform a winograd convolution operation on the sub convolutional kernel and corresponding target sub input data to obtain a convolution result corresponding to the sub convolutional kernel; and

a summation unit 604 configured to perform a summation operation on convolution results corresponding to the plurality of sub convolutional kernels to obtain a convolution result of the convolutional kernel and the input data.

In a possible implementation, the convolutional kernel splitting unit 601 is specifically used to:

split the convolutional kernel into the plurality of sub convolutional kernels with the size less than or equal to 3*3 that do not overlap with each other.

In a possible implementation, the input data splitting unit 602 includes:

a first splitting sub-unit configured to split the input data into a plurality of pieces of first sub input data based on the position distributions of the plurality of sub convolutional kernels in the convolutional kernel, where any one of the sub convolutional kernels has uniquely-corresponding first sub input data;

a second splitting sub-unit configured to, for any one of the sub convolutional kernels, split first sub input data with a size greater than 4*4 into a plurality of pieces of second sub input data with the size less than or equal to 4*4 if a size of the first sub input data corresponding to the sub convolutional kernel is greater than 4*4; and

a determining sub-unit configured to determine the plurality of pieces of second sub input data with the size less than or equal to 4*4 as the target sub input data corresponding to the sub convolutional kernel.

In a possible implementation, a determining sub-unit is further configured to, for any one of the sub convolutional kernels, determine the first sub input data as the target sub input data corresponding to the sub convolutional kernel if the size of the first sub input data corresponding to the sub convolutional kernel is less than or equal to 4*4.

In a possible implementation, for any one of the sub convolutional kernels, a corresponding relationship between the sub convolutional kernel and the first sub input data is as follows:

a position of a first element in the sub convolutional kernel in the convolutional kernel is the same as that of the first element of corresponding first sub input data in the input data; and

the first sub input data is composed of elements that the sub convolutional kernel is able to traverse when the convolutional kernel traverses elements of the input data.

In a possible implementation, the convolution unit 603 includes:

a first splitting sub-unit configured to split a winograd forward transformation of the target sub input data into a summation computation and perform the summation computation to obtain a winograd forward transformation result of the target sub input data;

a second splitting sub-unit configured to split a winograd forward transformation of the sub convolutional kernel into the summation computation and perform the summation computation to obtain a winograd forward transformation result of the sub convolutional kernel;

an element-wise multiplication sub-unit configured to perform an element-wise multiplication on the winograd forward transformation result of the target sub input data and the winograd forward transformation result of the sub convolutional kernel to obtain an element-wise multiplication result; and

a summation sub-unit configured to split a winograd backward transformation of the element-wise multiplication result into the summation computation and perform the summation computation to obtain the convolution result corresponding to the sub convolutional kernel.

In a possible implementation, the first splitting sub-unit includes:

a first splitting unit configured to split the target sub input data into a plurality of first sub-tensors and perform the winograd forward transformation and the summation computation on the plurality of first sub-tensors to obtain the winograd forward transformation result of the target sub input data, where

the number of the plurality of first sub-tensors is the same as the number of non-zero elements in the target sub input data, and one element of at least one first sub-tensor in the plurality of first sub-tensors is the same as an element at a corresponding position in the target sub input data, and all other elements are 0.

In a possible implementation, the first splitting unit is specifically used to:

obtain a winograd forward transformation result of a first meta-tensor corresponding to a first sub-tensor, where for the first meta-tensor corresponding to the first sub-tensor, an element value at a first position in the first sub-tensor is 1, where the first position is the same as a position of a non-zero element in the first sub-tensor;

multiply a non-zero element value in the first sub-tensor, as a coefficient, by a corresponding winograd forward transformation result of the first meta-tensor to obtain a winograd forward transformation result of the first sub-tensor; and

sum winograd forward transformation results of the plurality of first sub-tensors to obtain the winograd forward transformation result of the target sub input data.

In a possible implementation, the apparatus 600 further includes:

a first preprocessing unit configured to obtain the winograd forward transformation result of the first meta-tensor corresponding to the first sub-tensor in advance by the following processes:

for the first sub-tensor, obtaining the winograd forward transformation result of the first meta-tensor by multiplying a left side of the first meta-tensor corresponding to the first sub-tensor by a forward transformation left-multiply matrix and by multiplying a right side of the first meta-tensor corresponding to the first sub-tensor by a forward transformation right-multiply matrix.

In a possible implementation, the second splitting sub-unit includes:

a second splitting unit configured to split the sub convolutional kernel into a plurality of second sub-tensors and perform the winograd forward transformation and the summation computation on the plurality of second sub-tensors to obtain the winograd forward transformation result of the sub convolutional kernel, where

the number of the plurality of second sub-tensors is the same as the number of non-zero elements in the sub convolutional kernel, and one element of at least one second sub-tensor in the plurality of second sub-tensors is the same as the element at the corresponding position in the sub convolutional kernel, and all other elements are 0.

In a possible implementation, the second splitting unit is specifically used to:

obtain a winograd forward transformation result of a second sub-tensor corresponding to a second sub-tensor, where for the second meta-tensor corresponding to the second sub-tensor, an element value at a second position in the second sub-tensor is 1, where the second position in the second sub-tensor is the same as the position of the non-zero element value in the second sub-tensor.

multiply the non-zero element value in the second sub-tensor, as the coefficient, by the corresponding winograd forward transformation result of the second meta-tensor to obtain a winograd forward transformation result of the second sub-tensor; and

sum winograd forward transformation results of the plurality of the second sub-tensor to obtain the winograd forward transformation result of the sub convolutional kernel.

In a possible implementation, the apparatus 600 further includes:

a second preprocessing unit configured to obtain the winograd forward transformation result of the second meta-tensor corresponding to the second sub-tensor in advance by the following processes:

for the second sub-tensor, obtaining the winograd forward transformation result of the second meta-tensor by multiplying a left side of the second meta-tensor corresponding to the second sub-tensor by a forward transformation left-multiply matrix and by multiplying a right side of the second meta-tensor corresponding to the second sub-tensor by a forward transformation right-multiply matrix.

In a possible implementation, the summation sub-unit includes:

a third splitting unit configured to split an element-wise multiplication result into a plurality of third sub-tensors and perform the winograd backward transformation and the summation computation on the plurality of third sub-tensors to obtain the convolution result corresponding to the sub convolutional kernel, where

the number of the plurality of third sub-tensors is the same as the number of non-zero elements in the element-wise multiplication result, and one element of at least one third sub-tensor in the plurality of third sub-tensors is the same as the element at the corresponding position in the element-wise multiplication result, and all other elements are 0.

In a possible implementation, the third splitting unit is specifically used to:

obtain a winograd backward transformation result of a third sub-tensor corresponding to a third sub-tensor, where for the third meta-tensor corresponding to the third sub-tensor, an element value at a third position in the third sub-tensor is 1, where the third position in the second sub-tensor is the same as the position of the non-zero element in the second sub-tensor;

multiply the non-zero element value in the third sub-tensor, as the coefficient, by the corresponding winograd backward transformation result of the third meta-tensor to obtain a winograd backward transformation result of the third sub-tensor; and

sum winograd backward transformation results of the plurality of third sub-tensors to obtain the convolution result corresponding to the sub convolutional kernel.

In a possible implementation, the apparatus 600 further includes:

a third preprocessing unit configured to obtain the winograd backward transformation result of the third meta-tensor in advance by the following processes:

for the third sub-tensor, obtaining the winograd backward transformation result of the third meta-tensor by multiplying a left side of the third meta-tensor corresponding to the third sub-tensor by an backward transformation left-multiply matrix and by multiplying a right side of the third meta-tensor corresponding to the third sub-tensor by an backward transformation right-multiply matrix backward transformation.

The data processing apparatus 60 of this disclosure is capable of implementing one or more steps in a method embodiment shown in FIG. 2 and achieving a same technical effect, which will not be repeated here to avoid repetition.

It should be understood that the foregoing device embodiments are only illustrative, and the device of the present disclosure may also be implemented in other ways. For example, a division of units/modules in the foregoing embodiment is only a logical function division, and there may be other division methods in actual implementations. For example, a plurality of units, modules, or components may be combined or integrated into another system, or some features may be omitted or may not be implemented.

In addition, unless otherwise specified, functional units/modules in the various embodiments of the present disclosure may be integrated into one unit/module. Alternatively, each unit/module may exist alone physically. Alternatively, two or more units/modules may be integrated together. The above-mentioned integrated units/modules may be implemented in the form of hardware or in the form of software program modules.

If the above-mentioned integrated units/modules are implemented in the form of hardware, the hardware may be a digital circuit, an analog circuit, and the like. Physical implementation of the hardware structure may include, but is not limited to, a transistor, a memristor, and the like. Unless otherwise specified, an artificial intelligence processor may be any suitable hardware processor, such as a central processing unit (CPU), a graphics processing unit (GPU), a field-programmable gate array (FPGA), a digital signal processor (DSP), an application-specific integrated circuit (ASIC), and the like. Unless otherwise specified, a storage unit may be any suitable magnetic storage medium or magneto-optical storage medium, such as a resistive random access memory (RRAM), a dynamic random access memory (DRAM), a static random access memory (SRAM), an enhanced dynamic random access memory (EDRAM), a high-bandwidth memory (HBM), a hybrid memory cube (HMC), and the like.

If the integrated units/modules are implemented in the form of software program modules and sold or used as an independent product, the product may be stored in a computer-readable memory. Based on such understanding, the technical solutions of the present disclosure essentially, or part of the present disclosure that contributes to the prior art, or all or part of technical solutions, may be embodied in the form of a software product that is stored in a memory. The software product includes several instructions used to enable a computer device (which may be a personal computer, a server, or a network device, and the like) to perform all or part of the steps of the method described in one or more embodiments of the present disclosure. The foregoing memory includes: a USB flash drive, a read-only memory (ROM), a random access memory (RAM), a mobile hard disk, a magnetic disk, or an optical disc, and at least one of medium that may store program codes.

In a possible implementation, an artificial intelligence chip is provided, which includes the above-mentioned data processing device.

In a possible implementation, a board card is provided, which includes a storage component, an interface device, a control component, and the artificial intelligence chip. The artificial intelligence chip is connected to the storage component, the control component, and the interface device, respectively; the storage component is configured to store data; the interface device is configured to implement data transfer between the artificial intelligence chip and an external device; and the control component is configured to monitor a state of the artificial intelligence chip.

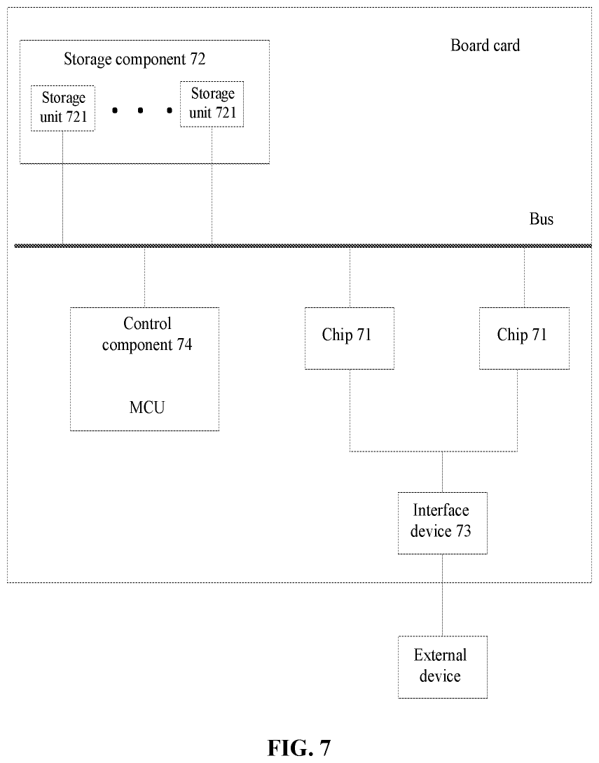

FIG. 7 illustrates a structural block diagram of a board card according to an embodiment of the present disclosure. As shown in FIG. 7, the board card may include, in addition to the artificial intelligence chip 71, other supporting components, which include, but are not limited to: a storage component 72, an interface device 73, and a control component 74.

The storage component 72 is connected to an artificial intelligence chip 71 via a bus and is used for storing data. The storage component 72 may include a plurality of groups of storage units 721. A storage unit 721 is connected to the artificial intelligence chip 72 via the bus. It may be understood that the storage unit 721 may be a double data rate (DDR) synchronous dynamic random access memory (SDRAM).

The DDR does not need to increase clock frequency to double a speed of the SDRAM. The DDR allows data to be read on rising and falling edges of a clock pulse. A speed of the DDR is twice as that of a standard SDRAM. In one embodiment, the storage component 72 may include four sets of storage units 721. The storage units 721 may include a plurality of DDR4 particles (chips). In one embodiment, the artificial intelligence chip 71 may include four 72-bit DDR4 controllers inside, where 64 bits are used for data transfer and 8 bits are used for an error checking and correcting (ECC) parity. It may be understood that when a DDR4-3200 particle is used in the storage units 721, a theoretical bandwidth of the data transfer may reach 25,600 MB/s.

In one embodiment, the storage units 721 may include a plurality of DDR SDRAMs arranged in parallel. The DDR may transfer data twice in one clock cycle. A controller for controlling the DDR is provided in the artificial intelligence chip and is used for the control of data transfer and data storage of one or more of the storage units.

The interface device may be electrically connected to the artificial intelligence chip. The interface device is used to implement data transfer between the artificial intelligence chip 71 and an external device, such as a server or a computer. In one embodiment, for example, the interface device 73 may be a standard a peripheral component interconnect express (PCIe) interface. For example, data to be processed is transferred from the server to the chip via a standard PCIe interface to realize the data transfer. Optionally, when a PCIe 3.0×16 interface is used for the data transfer, the theoretical bandwidth of the data transfer may reach 16,000 MB/s. In another embodiment, the interface device 73 may also be other interfaces, and the present disclosure does not limit the specific manifestation of the other interfaces mentioned above, as long as an interface unit 721 is able to realize a transfer function. In addition, a calculation result of the artificial intelligence chip 71 is still transmitted by the interface device 73 back to the external device (for example, the server).

The control component 74 is electrically connected to the artificial intelligence chip 71. The control component 74 is used to monitor a state of the artificial intelligence chip 71. Specifically, the artificial intelligence chip 71 and the control component 74 may be electrically connected via a serial peripheral interface (SPI). The control component 74 may include a micro controller unit (MCU). If the artificial intelligence chip 71 may include a plurality of processing chips, a plurality of processing cores, or a plurality of processing circuits, a plurality of loads may be driven. Therefore, the artificial intelligence chip 71 may be in different working states, such as a multi-load state and a light-load state. By the control component 74, regulation and control of the working states of the plurality of processing chips, the plurality of processing and/or the plurality of processing circuits in the artificial intelligence chip 71 may be achieved.

In a possible implementation, an electronic device is provided. The electronic device includes the artificial intelligence chip above. The electronic device includes a data processing device, a robot, a computer, a printer, a scanner, a tablet, a smart terminal, a mobile phone, a traffic recorder, a navigator, a sensor, a webcam, a server, a cloud-based server, a camera, a video camera, a projector, a watch, a headphone, a mobile storage, a wearable device, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiograph.

Embodiments of the present disclosure also provides a computer-readable storage medium, on which computer program instructions are stored, and the computer program instructions implement the method described above when executed by a processor. The computer-readable storage medium may be a non-transitory computer-readable storage medium.

The embodiments of the present disclosure also provides an electronic device including: processors; and a memory for storing instructions executable by the processors, where the processors are configured to invoke the instructions stored in the memory to perform the method described above.

In the embodiments above, the description of each embodiment have its own emphasis, and for the parts that are not detailed in a particular embodiment, reference may be made to related descriptions in other embodiments. Technical features of the above embodiments may be combined arbitrarily. For the sake of brevity, not all possible combinations of different technical features of the above embodiments are described, however, as long as these combinations of technical features are not contradictory, these combinations should be considered as falling within the scope of this specification.

The foregoing may be better understood according to the following articles:

A1.

A data processing method, comprising:

splitting a convolutional kernel with a size greater than 3*3 into a plurality of sub convolutional kernels with a size less than or equal to 3*3;

splitting input data into a plurality of pieces of target sub input data with a size less than or equal to 4*4 according to position distributions of the plurality of sub convolutional kernels in the convolutional kernel, where a sub convolutional kernel corresponds to one or more pieces of target sub input data;

for any one of the sub convolutional kernels, performing a winograd convolution operation on the sub convolutional kernel and corresponding target sub input data to obtain a convolution result corresponding to the sub convolutional kernel; and

performing a summation operation on convolution results corresponding to the plurality of sub convolutional kernels to obtain a convolution result of the convolutional kernel and the input data.

A2.

The method of A1, where splitting the convolutional kernel with the size greater than 3*3 into the plurality of sub convolutional kernels with the size less than or equal to 3*3 includes:

splitting the convolutional kernel into the plurality of sub convolutional kernels with the size less than or equal to 3*3 that do not overlap with each other.

A3.

The method of A1, where splitting the input data into the plurality of pieces of target sub input data with the size less than or equal to 4*4 according to the position distributions of the plurality of sub convolutional kernels in the convolutional kernel includes:

splitting the input data into a plurality of pieces of first sub input data according to the position distributions of the plurality of sub convolutional kernels in the convolutional kernel, where any one of the sub convolutional kernels has uniquely-corresponding first sub input data;

for any one of the sub convolutional kernels, splitting the first sub input data with a size greater than 4*4 into a plurality of pieces of second sub input data with the size less than or equal to 4*4 if a size of the first sub input data corresponding to the sub convolutional kernel is greater than 4*4; and

determining the plurality of pieces of second sub input data with the size less than or equal to 4*4 as the target sub input data corresponding to the sub convolutional kernel.

A4.

The method of A3, further comprising:

for any one of the sub convolutional kernels, determining the first sub input data as the target sub input data corresponding to the sub convolutional kernel if the size of the first sub input data corresponding to the sub convolutional kernel is less than or equal to 4*4.

A5.

The method of A3, where for any one of the sub convolutional kernels, a corresponding relationship between the sub convolutional kernel and the first sub input data is as follows:

a position of a first element of the sub convolutional kernel in the convolutional kernel is the same as a position of a first element of corresponding first sub input data in the input data; and

the first sub input data is composed of elements that the sub convolutional kernel is able to traverse when the convolutional kernel traverses elements of the input data.

A6.

The method of any one of A1-5, where for any one of the sub convolutional kernels, performing the winograd convolution operation on the sub convolutional kernel and the corresponding target sub input data to obtain the convolution result corresponding to the sub convolutional kernel includes:

splitting a winograd forward transformation of the target sub input data into a summation computation and performing the summation computation to obtain a winograd forward transformation result of the target sub input data;

splitting a winograd forward transformation of the sub convolutional kernel into the summation computation and performing the summation computation to obtain a winograd forward transformation result of the sub convolutional kernel;

performing an element-wise multiplication on the winograd forward transformation result of the target sub input data and the winograd forward transformation result of the sub convolutional kernel to obtain an element-wise multiplication result; and

splitting a winograd backward transformation of the element-wise multiplication result into the summation computation and performing the summation computation to obtain the convolution result corresponding to the sub convolutional kernel.

A7.

The method of A6, where splitting the winograd forward transformation of the target sub input data into the summation computation and performing the summation computation to obtain the winograd forward transformation result of the target sub input data include:

splitting the target sub input data into a plurality of first sub-tensors, and performing the winograd forward transformation and the summation computation on the plurality of first sub-tensors to obtain the winograd forward transformation result of the target sub input data, where

the number of the plurality of first sub-tensors is the same as the number of non-zero elements in the target sub input data, and one element of at least one first sub-tensor in the plurality of first sub-tensors is the same as an element at a corresponding position in the target sub input data, and all other elements are 0.

A8.

The method of A7, where performing the winograd forward transformation and the summation computation on the plurality of first sub-tensors to obtain the winograd forward transformation result of the target sub input data includes:

obtaining a winograd forward transformation result of a first meta-tensor corresponding to a first sub-tensor, where for the first meta-tensor corresponding to the first sub-tensor, an element value at a first position in the first meta-tensor is 1, where the first position in the first meta-tensor is the same as a position of a non-zero element in the first sub-tensor;

multiplying a non-zero element value in the first sub-tensor, as a coefficient, by a corresponding winograd forward transformation result of the first meta-tensor to obtain a winograd forward transformation result of the first sub-tensor; and

summing winograd forward transformation results of the plurality of first sub-tensors to obtain the winograd forward transformation result of the target sub input data.

A9.

The method of A8, where the winograd forward transformation result of the first meta-tensor corresponding to the first sub-tensor is obtained in advance by the following processes:

for the first sub-tensor, the winograd forward transformation result of the first meta-tensor is obtained by multiplying a left side of the first meta-tensor corresponding to the first sub-tensor by a forward transformation left-multiply matrix and by multiplying a right side of the first meta-tensor corresponding to the first sub-tensor by a forward transformation right-multiply matrix.

A10.

The method of A6, where splitting the winograd forward transformation of the sub convolutional kernel into the summation computation and performing the summation computation to obtain the winograd forward transformation result of the sub convolutional kernel include.

splitting the sub convolutional kernel into a plurality of second sub-tensors, and performing the winograd forward transformation and the summation computation on the plurality of second sub-tensors to obtain the winograd forward transformation result of the sub convolutional kernel, where

the number of the plurality of second sub-tensors is the same as the number of non-zero elements in the sub convolutional kernel, and one element of at least one second sub-tensor in the plurality of second sub-tensors is the same as an element at a corresponding position in the sub convolutional kernel, and all other elements are 0.

A11.

The method of A10, where performing the winograd forward transformation and the summation computation on the plurality of second sub-tensors to obtain the winograd forward transformation result of the sub convolutional kernel includes:

obtaining a winograd forward transformation result of a second meta-tensor corresponding to a second sub-tensor, where for the second meta-tensor corresponding to the second sub-tensor, an element value at a second position in the second meta-tensor is 1, where the second position in the second meta-tensor is the same as a position of a non-zero element in the second sub-tensor;

multiplying a non-zero element value in the second sub-tensor, as a coefficient, by a corresponding winograd forward transformation result of the second meta-tensor to obtain a winograd forward transformation result of the second sub-tensor; and

summing winograd forward transformation results of the plurality of second sub-tensors to obtain the winograd forward transformation result of the sub convolutional kernel.

A12.

The method of A11, where the winograd forward transformation result of the second meta-tensor corresponding to the second sub-tensor is obtained in advance by the following processes:

for the second sub-tensor, the winograd forward transformation result of the second meta-tensor is obtained by multiplying a left side of the second meta-tensor corresponding to the second sub-tensor by a forward transformation left-multiply matrix and by multiplying a right side of the second meta-tensor corresponding to the second sub-tensor by a forward transformation right-multiply matrix.

A13.

The method of A6, where splitting the winograd backward transformation of the element-wise multiplication result into the summation operation and performing the summation computation to obtain the convolution result corresponding to the sub convolutional kernel include:

splitting the element-wise multiplication result into a plurality of third sub-tensors, and performing the winograd backward transformation and the summation computation on the plurality of third sub-tensors to obtain the convolution result corresponding to the sub convolutional kernel, where

the number of the plurality of third sub-tensors is the same as the number of non-zero elements in the element-wise multiplication result, and one element of at least one third sub-tensor in the plurality of third sub-tensors is the same as an element at a corresponding position in the element-wise multiplication result, and all other elements are 0.

A14.

The method of A13, where performing the winograd backward transformation and the summation computation on the plurality of third sub-tensors to obtain the convolution result corresponding to the sub convolutional kernel includes:

obtaining a winograd backward transformation result of a third meta-tensor corresponding to a third sub-tensor, where for the third meta-tensor corresponding to the third sub-tensor, an element value at a third position in the third meta-tensor is 1, where the third position in the second meta-tensor is the same as a position of a non-zero element in the second sub-tensor;

multiplying a non-zero element value in the third sub-tensor, as a coefficient, by a corresponding winograd backward transformation result of the third meta-tensor to obtain a winograd backward transformation result of the third sub-tensor; and

summing winograd backward transformation results of the plurality of third sub-tensors to obtain the convolution result corresponding to the sub convolutional kernel.

A15.

The method of A14, where the winograd backward transformation result of the third meta-tensor is obtained in advance by the following processes:

for the third sub-tensor, the winograd backward transformation result of the third meta-tensor is obtained by multiplying a left side of the third meta-tensor corresponding to the third sub-tensor by an backward transformation left-multiply matrix and by multiplying a right side of the third meta-tensor corresponding to the third sub-tensor by an backward transformation right-multiply matrix.

A16.

A data processing apparatus, comprising:

a convolutional kernel splitting unit configured to split a convolutional kernel with a size greater than 3*3 into a plurality of sub convolutional kernels with a size less than or equal to 3*3;

an input data splitting unit configured to split input data into a plurality of pieces of target sub input data with a size less than or equal to 4*4 according to position distributions of the plurality of sub convolutional kernels in the convolutional kernel, where a sub convolutional kernel corresponds to one or more pieces of target sub input data;

a convolution unit configured to, for any one of the sub convolutional kernels, perform a winograd convolution operation on the sub convolutional kernel and corresponding target sub input data to obtain a convolution result corresponding to the sub convolutional kernel; and

a summation unit configured to perform a summation operation on convolution results corresponding to the plurality of sub convolutional kernels to obtain a convolution result of the convolutional kernel and the input data.

A17.

The apparatus of A16, where the convolutional kernel splitting unit is specifically configured to:

split the convolutional kernel into the plurality of sub convolutional kernels with the size less than or equal to 3*3 that do not overlap with each other.

A18.

The apparatus of A15, where the input data splitting unit includes:

a first splitting sub-unit configured to split the input data into a plurality of pieces of first sub input data based on the position distributions of the plurality of sub convolutional kernels in the convolutional kernel, where any one of the sub convolutional kernels has uniquely-corresponding first sub input data;

a second splitting sub-unit configured to, for any one of the sub convolutional kernels, split first sub input data with a size greater than 4*4 into a plurality of pieces of second sub input data with the size less than or equal to 4*4 if a size of the first sub input data corresponding to the sub convolutional kernel is greater than 4*4; and

a determining sub-unit configured to determine the plurality of pieces of second sub input data with the size less than or equal to 4*4 as the target sub input data corresponding to the sub convolutional kernel.

A19.

The apparatus of A18, where the determining sub-unit is further configured to, for any one of the sub convolutional kernels, determine the first sub input data as the target sub input data corresponding to the sub convolutional kernel if the size of the first sub input data corresponding to the sub convolutional kernel is less than or equal to 4*4.

A20.

The apparatus of A18, where for any one of the sub convolutional kernels, a corresponding relationship between the sub convolutional kernel and the first sub input data is as follows:

a position of a first element in the sub convolutional kernel in the convolutional kernel is the same as a position of a first element of corresponding first sub input data in the input data; and

the first sub input data is composed of elements that the sub convolutional kernel is able to traverse when the convolutional kernel traverses elements of the input data.

A21.

The apparatus of any one of A16-A20, where the convolution unit includes:

a first splitting sub-unit configured to split a winograd forward transformation of the target sub input data into a summation computation and perform the summation computation to obtain a winograd forward transformation result of the target sub input data;

a second splitting sub-unit configured to split a winograd forward transformation of the sub convolutional kernel into the summation computation and perform the summation computation to obtain a winograd forward transformation result of the sub convolutional kernel;

an element-wise multiplication sub-unit configured to perform an element-wise multiplication on the winograd forward transformation result of the target sub input data and the winograd forward transformation result of the sub convolutional kernel to obtain an element-wise multiplication result; and

a summation sub-unit configured to split a winograd backward transformation of the element-wise multiplication result into the summation computation and perform the summation computation to obtain the convolution result corresponding to the sub convolutional kernel.

A22.

The apparatus of A21, where the first splitting sub-unit includes:

a first splitting unit configured to split the target sub input data into a plurality of first sub-tensors and perform the winograd forward transformation and the summation computation on the plurality of first sub-tensors to obtain the winograd forward transformation result of the target sub input data, where

the number of the plurality of first sub-tensors is the same as the number of non-zero elements in the target sub input data, and one element of at least one first sub-tensor in the plurality of first sub-tensors is the same as an element at a corresponding position in the target sub input data, and all other elements are 0.

A23.

The apparatus of A22, where the first splitting unit includes:

obtaining a winograd forward transformation result of a first meta-tensor corresponding to a first sub-tensor, where for the first meta-tensor corresponding to the first sub-tensor, an element value at a first position in the first meta-tensor is 1, where the first position of the first meta-tensor is the same as a position of a non-zero element in the first sub-tensor;

multiplying a non-zero element value in the first sub-tensor, as a coefficient, by a corresponding winograd forward transformation result of the first meta-tensor to obtain a winograd forward transformation result of the first sub-tensor; and

summing winograd forward transformation results of the plurality of first sub-tensors to obtain the winograd forward transformation result of the target sub input data.

A24.

The apparatus of A23, further comprising:

a first preprocessing unit configured to obtain the winograd forward transformation result of the first meta-tensor corresponding to the first sub-tensor in advance by the following processes:

for the first sub-tensor, obtaining the winograd forward transformation result of the first meta-tensor by multiplying a left side of the first meta-tensor corresponding to the first sub-tensor by a forward transformation left-multiply matrix and by multiplying a right side of the first meta-tensor corresponding to the first sub-tensor by a forward transformation right-multiply matrix.

A25.

The apparatus of A21, where the second splitting sub-unit includes:

a second splitting unit configured to split the sub convolutional kernel into a plurality of second sub-tensors and perform the winograd forward transformation and the summation computation on the plurality of second sub-tensors to obtain the winograd forward transformation result of the sub convolutional kernel, where

the number of the plurality of second sub-tensors is the same as the number of non-zero elements in the sub convolutional kernel, and one element of at least one second sub-tensor in the plurality of second sub-tensors is the same as an element at a corresponding position in the sub convolutional kernel, and all other elements are 0.

A26.

The apparatus of A25, where the second splitting unit is specifically configured to:

obtain a winograd forward transformation result of a second meta-tensor corresponding to a second sub-tensor, where for the second meta-tensor corresponding to the second sub-tensor, an element value at a second position in the second meta-tensor is 1, where the second position in the second meta-tensor is the same as a position of a non-zero element in the second sub-tensor;

multiply a non-zero element value in the second sub-tensor, as a coefficient, by a corresponding winograd forward transformation result of the second meta-tensor to obtain a winograd forward transformation result of the second sub-tensor; and

sum winograd forward transformation results of the plurality of second sub-tensors to obtain the winograd forward transformation result of the sub convolutional kernel.

A27.

The apparatus of A26, further comprising:

a second preprocessing unit configured to obtain the winograd forward transformation result of the second meta-tensor corresponding to the second sub-tensor in advance by the following processes:

for the second sub-tensor, obtaining the winograd forward transformation result of the second meta-tensor by multiplying a left side of the second meta-tensor corresponding to the second sub-tensor by a forward transformation left-multiply matrix and by multiplying a right side of the second meta-tensor corresponding to the second sub-tensor by a forward transformation right-multiply matrix.

A28.

The apparatus of A21, where the summation sub-unit includes:

a third splitting unit configured to split an element-wise multiplication result into a plurality of third sub-tensors and perform the winograd backward transformation and the summation computation on the plurality of third sub-tensors to obtain the convolution result corresponding to the sub convolutional kernel, where

the number of the plurality of third sub-tensors is the same as the number of non-zero elements in the element-wise multiplication result, and one element of at least one third sub-tensor in the plurality of third sub-tensors is the same as an element at a corresponding position in the element-wise multiplication result, and all other elements are 0.

A29.

The apparatus of A28, where the third splitting unit is specifically configured to:

obtain a winograd backward transformation result of a third meta-tensor corresponding to a third sub-tensor, where for the third meta-tensor corresponding to the third sub-tensor, an element value at a third position in the third meta-tensor is 1, where the third position in the second meta-tensor is the same as a position of a non-zero element in the second sub-tensor;

multiply anon-zero element value in the third sub-tensor, as a coefficient, by a corresponding winograd backward transformation result of the third meta-tensor to obtain a winograd backward transformation result of the third sub-tensor; and

sum winograd backward transformation results of the plurality of third sub-tensors to obtain the convolution result corresponding to the sub convolutional kernel.

A30.

The apparatus of A29, further comprising:

a third preprocessing unit configured to obtain the winograd backward transformation result of the third meta-tensor in advance by the following processes:

for the third sub-tensor, obtaining the winograd backward transformation result of the third meta-tensor by multiplying a left side of the third meta-tensor corresponding to the third sub-tensor by an backward transformation left-multiply matrix and by multiplying a right side of the third meta-tensor corresponding to the third sub-tensor by an backward transformation right-multiply matrix backward transformation.

A31.

An artificial intelligence chip, comprising the data processing apparatus of A16-A30.

A32.

An electronic device, comprising the artificial intelligence chip of A31.

A33.

An electronic device, comprising:

processors; and

a memory for storing instructions executable by the processors, where

the processors are configured to invoke the instructions stored in the memory to perform the data processing method of any one of A1-A15.

A34.

A computer-readable storage medium, on which a computer program instruction is stored, where when the computer program instruction is executed, the data processing method of any one of A1-A15 is performed.

What is claimed:

1. A data processing method, comprising:
splitting a convolutional kernel with a size greater than 3*3 into a plurality of sub convolutional kernels with a size less than or equal to 3*3;
splitting input data into a plurality of pieces of target sub input data with a size less than or equal to 4*4 according to position distributions of the plurality of sub convolutional kernels in the convolutional kernel, wherein a sub convolutional kernel corresponds to one or more pieces of target sub input data;
for any one of the sub convolutional kernels, performing a winograd convolution operation on the sub convolutional kernel and corresponding target sub input data to obtain a convolution result corresponding to the sub convolutional kernel; and
performing a summation operation on convolution results corresponding to the plurality of sub convolutional kernels to obtain a convolution result of the convolutional kernel and the input data.

2. The method of claim 1, wherein splitting the convolutional kernel with the size greater than 3*3 into the plurality of sub convolutional kernels with the size less than or equal to 3*3 includes:
splitting the convolutional kernel into the plurality of sub convolutional kernels with the size less than or equal to 3*3 that do not overlap with each other.

3. The method of claim 1, wherein splitting the input data into the plurality of pieces of target sub input data with the size less than or equal to 4*4 according to the position distributions of the plurality of sub convolutional kernels in the convolutional kernel includes:
splitting the input data into a plurality of pieces of first sub input data according to the position distributions of the plurality of sub convolutional kernels in the convolutional kernel, wherein any one of the sub convolutional kernels has uniquely-corresponding first sub input data;
for any one of the sub convolutional kernels, splitting first sub input data with a size greater than 4*4 into a plurality of pieces of second sub input data with the size less than or equal to 4*4 if a size of the first sub input data corresponding to the sub convolutional kernel is greater than 4*4; and
determining the plurality of pieces of second sub input data with the size less than or equal to 4*4 as the target sub input data corresponding to the sub convolutional kernel.

4. The method of claim 3, further comprising:
for any one of the sub convolutional kernels, determining the first sub input data as the target sub input data corresponding to the sub convolutional kernel if the size of the first sub input data corresponding to the sub convolutional kernel is less than or equal to 4*4.

5. The method of claim 3, wherein for any one of the sub convolutional kernels, a corresponding relationship between the sub convolutional kernel and the first sub input data is as follows:
a position of a first element of the sub convolutional kernel in the convolutional kernel is the same as a position of a first element of corresponding first sub input data in the input data; and
the first sub input data is composed of elements that the sub convolutional kernel is able to traverse when the convolutional kernel traverses elements of the input data.

6. The method of claim 1, wherein for any one of the sub convolutional kernels, performing the winograd convolution operation on the sub convolutional kernel and the corresponding target sub input data to obtain the convolution result corresponding to the sub convolutional kernel includes:
splitting a winograd forward transformation of the target sub input data into a summation computation and performing the summation computation to obtain a winograd forward transformation result of the target sub input data;
splitting a winograd forward transformation of the sub convolutional kernel into the summation computation and performing the summation computation to obtain a winograd forward transformation result of the sub convolutional kernel;
performing an element-wise multiplication on the winograd forward transformation result of the target sub input data and the winograd forward transformation result of the sub convolutional kernel to obtain an element-wise multiplication result; and
splitting a winograd backward transformation of the element-wise multiplication result into the summation computation and performing the summation computation to obtain the convolution result corresponding to the sub convolutional kernel.

7. The method of claim 6, wherein splitting the winograd forward transformation of the target sub input data into the summation computation and performing the summation computation to obtain the winograd forward transformation result of the target sub input data include:
splitting the target sub input data into a plurality of first sub-tensors, and performing the winograd forward transformation and the summation computation on the plurality of first sub-tensors to obtain the winograd forward transformation result of the target sub input data, wherein
the number of the plurality of first sub-tensors is the same as the number of non-zero elements in the target sub input data, and one element of at least one first sub-tensor in the plurality of first sub-tensors is the same as an element at a corresponding position in the target sub input data, and all other elements are 0.

8. The method of claim 7, wherein performing the winograd forward transformation and the summation computation on the plurality of first sub-tensors to obtain the winograd forward transformation result of the target sub input data includes:
obtaining a winograd forward transformation result of a first meta-tensor corresponding to a first sub-tensor, wherein for the first meta-tensor corresponding to the first sub-tensor, an element value at a first position in the first meta-tensor is 1, wherein the first position in the first meta-tensor is the same as a position of a non-zero element in the first sub-tensor;
multiplying a non-zero element value in the first sub-tensor, as a coefficient, by a corresponding winograd forward transformation result of the first meta-tensor to obtain a winograd forward transformation result of the first sub-tensor; and
summing winograd forward transformation results of the plurality of first sub-tensors to obtain the winograd forward transformation result of the target sub input data.

9. The method of claim 8, wherein the winograd forward transformation result of the first meta-tensor corresponding to the first sub-tensor is obtained in advance by the following processes:
for the first sub-tensor, the winograd forward transformation result of the first meta-tensor is obtained by multiplying a left side of the first meta-tensor corresponding to the first sub-tensor by a forward transformation left-multiply matrix and by multiplying a right side of the first meta-tensor corresponding to the first sub-tensor by a forward transformation right-multiply matrix.

10. The method of claim 6, wherein splitting the winograd forward transformation of the sub convolutional kernel into the summation computation and performing the summation computation to obtain the winograd forward transformation result of the sub convolutional kernel include:
splitting the sub convolutional kernel into a plurality of second sub-tensors, and performing the winograd forward transformation and the summation computation on the plurality of second sub-tensors to obtain the winograd forward transformation result of the sub convolutional kernel, wherein
the number of the plurality of second sub-tensors is the same as the number of non-zero elements in the sub convolutional kernel, and one element of at least one second sub-tensor in the plurality of second sub-tensors is the same as an element at a corresponding position in the sub convolutional kernel, and all other elements are 0.

11. The method of claim 10, wherein performing the winograd forward transformation and the summation computation on the plurality of second sub-tensors to obtain the winograd forward transformation result of the sub convolutional kernel includes:
obtaining a winograd forward transformation result of a second meta-tensor corresponding to a second sub-tensor, wherein for the second meta-tensor corresponding to the second sub-tensor, an element value at a second position in the second meta-tensor is 1, wherein the second position in the second meta-tensor is the same as a position of a non-zero element in the second sub-tensor;
multiplying a non-zero element value in the second sub-tensor, as a coefficient, by a corresponding winograd forward transformation result of the second meta-tensor to obtain a winograd forward transformation result of the second sub-tensor; and
summing winograd forward transformation results of the plurality of second sub-tensors to obtain the winograd forward transformation result of the sub convolutional kernel.

12. The method of claim 11, wherein the winograd forward transformation result of the second meta-tensor corresponding to the second sub-tensor is obtained in advance by the following processes:
for the second sub-tensor, the winograd forward transformation result of the second meta-tensor is obtained by multiplying a left side of the second meta-tensor corresponding to the second sub-tensor by a forward transformation left-multiply matrix and by multiplying a right side of the second meta-tensor corresponding to the second sub-tensor by a forward transformation right-multiply matrix.

13. The method of claim 6, wherein splitting the winograd backward transformation of the element-wise multiplication result into the summation computation and performing the summation computation to obtain the convolution result corresponding to the sub convolutional kernel include:
splitting the element-wise multiplication result into a plurality of third sub-tensors, and performing the winograd backward transformation and the summation computation on the plurality of third sub-tensors to obtain the convolution result corresponding to the sub convolutional kernel, wherein
the number of the plurality of third sub-tensors is the same as the number of non-zero elements in the element-wise multiplication result, and one element of at least one third sub-tensor in the plurality of third sub-tensors is the same as an element at a corresponding position in the element-wise multiplication result, and all other elements are 0.

14. The method of claim 13, wherein performing the winograd backward transformation and the summation computation on the plurality of third sub-tensors to obtain the convolution result corresponding to the sub convolutional kernel includes:
obtaining a winograd backward transformation result of a third meta-tensor corresponding to a third sub-tensor, wherein for the third meta-tensor corresponding to the third sub-tensor, an element value at a third position in the third meta-tensor is 1, wherein the third position in the second meta-tensor is the same as a position of a non-zero element in the second sub-tensor;
multiplying a non-zero element value in the third sub-tensor, as a coefficient, by a corresponding winograd backward transformation result of the third meta-tensor to obtain a winograd backward transformation result of the third sub-tensor; and
summing winograd backward transformation results of the plurality of third sub-tensors to obtain the convolution result corresponding to the sub convolutional kernel.

15. The method of claim 14, wherein the winograd backward transformation result of the third meta-tensor is obtained in advance by the following processes:
for the third sub-tensor, the winograd backward transformation result of the third meta-tensor is obtained by multiplying a left side of the third meta-tensor corresponding to the third sub-tensor by an backward transformation left-multiply matrix and by multiplying a right side of the third meta-tensor corresponding to the third sub-tensor by an backward transformation right-multiply matrix.

16. A data processing apparatus, comprising:
a convolutional kernel splitting circuit configured to split a convolutional kernel with a size greater than 3*3 into a plurality of sub convolutional kernels with a size less than or equal to 3*3;
an input data splitting circuit configured to split input data into a plurality of pieces of target sub input data with a size less than or equal to 4*4 according to position distributions of the plurality of sub convolutional kernels in the convolutional kernel, wherein a sub convolutional kernel corresponds to one or more pieces of target sub input data;
a convolution circuit configured to, for any one of the sub convolutional kernels, perform a winograd convolution operation on the sub convolutional kernel and corresponding target sub input data to obtain a convolution result corresponding to the sub convolutional kernel; and
a summation circuit configured to perform a summation operation on convolution results corresponding to the plurality of sub convolutional kernels to obtain a convolution result of the convolutional kernel and the input data.

17-20. (canceled)
